(19) United States
(12) Patent Application Publication
(10) Pub. No.: US 2018/0207648 A1
(43) Pub. Date: Jul. 26, 2018

(54) Working Fluid Filtration And Separation System

(71) Applicant: IOT Diagnostics LLC, Cincinnati, OH (US)

(72) Inventors: Bill Stull, Florence, KY (US); Jon Prescott, Lexington, KY (US); Mike Hoskins, Batavia, OH (US)

(21) Appl. No.: 15/879,777

(22) Filed: Jan. 25, 2018

Related U.S. Application Data
(60) Provisional application No. 62/450,346, filed on Jan. 25, 2017.

(51) Int. Cl. B03C 5/02; B01D 35/06

(52) U.S. Cl. CPC B03C 5/02; B03C 2201/18; B01D 35/06

(57) ABSTRACT

A working fluid filtration and separation system that removes contaminants from a working fluid of a working machine. The system includes a vessel and an electrostatic collector mounted within the vessel which electrostatically removes contaminants from contaminated working fluid as it passes through the electrostatic collector element. The electrostatic collector element includes a plurality of concentric electrodes of different radii, a plurality of corrugated walls residing in spaces located between adjacent electrodes. An elongated center post electrode is provided that induces a voltage in at least one of the plurality of concentric electrodes. The system is configured to generate a voltage difference between each pair of adjacent concentric electrodes to electrostatically remove contaminants from the working fluid as it flows through the filtration and separation system. The system further includes a center post isolator that is configured to mount the center post isolator within the vessel and electrically insulate the center post electrode from the vessel.

The present application claims the filing benefit of U.S. Provisional Application Ser. No. 62/450,346, filed Jan. 25, 2017, the disclosure of which is incorporated herein by reference in its entirety.

### FIELD OF THE INVENTION

The present invention relates generally to fluid circuits and, more particularly, to a device for filtration and separation of contaminants in a working fluid of a working machine.

### BACKGROUND OF THE INVENTION

Working machines often utilize fluid power systems to perform work, such as to run hydraulic motors or to extend and retract cylinders in various manufacturing or production environments. One exemplary fluid power system may include a pump acting upon hydraulic fluid to perform the desired work of the working machine, such as an injection molding machine, for example. During operation, the working fluid in such systems typically degrades, and various contaminants, such as particulates and varnish, may accumulate in the working fluid. Over time, the accumulation of the contaminants may degrade mechanical components of the hydraulic power system, such as the bearings and gears of the system, which can lead to significant downtime for either cleaning the working machine and/or repairing or replacing one or more parts of the machine.

One known approach for removing insoluble contaminants from the working fluid is to use a filtration system having an electrostatic collector to remove particulates and varnish from non-conducting oils used as the working fluid. Conventional filtration systems, however, suffer from a number of drawbacks including mechanical failure due to material degradation resulting from stress concentration in various mechanical parts of the filtration system as the system is operated.

It would therefore be desirable to provide an improvement that addresses these and other problems associated with conventional filtration systems designed for removal of contaminants from working fluids.

### SUMMARY OF THE INVENTION

The present invention overcomes the foregoing and other shortcomings and drawbacks of working fluid filtration and separation systems heretofore known. While the invention will be described in connection with certain embodiments, it will be understood that the invention is not limited to these embodiments. On the contrary, the invention includes all alternatives, modifications and equivalents as may be included within the spirit and scope of the present invention.

According to one embodiment of the present invention, a working fluid filtration and separation system is provided for removing contaminants from a working fluid of a working machine. The system includes a vessel and an electrostatic collector element mounted within the vessel which electrostatically removes contaminants from the contaminated working fluid as it passes through the electrostatic collector element.

In one embodiment, the electrostatic collector element includes a plurality of concentric electrodes of different radii and a plurality of filters residing in spaces located between adjacent electrodes. An elongated center post electrode is mounted within a space defined by an inner-most electrode of the electrostatic collector element and is electrically coupled to at least one of the plurality of concentric electrodes.

The system includes a center post isolator that is mounted adjacent a bottom end of the vessel that is configured to mount the center post electrode within the vessel and electrically insulate the center post electrode from the vessel.

An electrical conductor is at least partially mounted within the center post insulator, and is mechanically and electrically coupled to the center post isolator and configured to apply a voltage to the center post electrode.

The electrostatic collector element is operable to remove contaminants from the working fluid in response to the voltage being applied to the center post electrode.

In this way, the system is configured and operable to electrostatically remove contaminants from the working fluid as it flows through the filtration and separation system.

According to one embodiment, the working fluid filtration and separation system includes a pump that is configured to circulate the working fluid through the vessel. The pump may comprise one of a variable frequency drive or a variable displacement pump.

The working fluid filtration and separation system also includes a control system that is configured to control the voltage applied to the center post electrode and operation of the pump so as to control a flow rate of the working fluid between and inlet and outlet of the filtration and separation system.

The system may include one or more sensors that are configured to measure at least one of temperature, pressure, humidity or flow rate of the working fluid at a selected location between an inlet and outlet of the system.

The system may also include one or more sensors that are configured to measure a volume density of particulate contaminants in the working fluid, a presence of water in the working fluid, a dielectric strength of the working fluid, an electric charge or electric field strength of the working fluid and/or a chemical spectrum of the working fluid at a selected location between an inlet and outlet of the system.

The above and other objectives of the present invention shall be made apparent from the accompanying drawings and description thereof.

### BRIEF DESCRIPTION OF THE DRAWINGS

The accompanying drawings, which are incorporated in and constitute a part of this specification, illustrate an embodiment of the invention and, together with a general description of the invention given above, and the detailed description of the embodiments given below, serve to explain the principles of the invention.

FIG. 1 is a schematic illustration of an exemplary fluid power system including a primary fluid circuit providing working fluid to a working machine and a secondary fluid circuit providing contaminated working fluid to be cleaned to a working fluid filtration and separation system for removal of contaminants from the working fluid according to one embodiment of the present invention;

FIG. 2 is an exemplary block diagram of the working fluid filtration and separation system shown in FIG. 1;

FIG. 3 is a rear perspective view of an exemplary working fluid filtration and separation system according to one embodiment;

FIG. 4 is a front perspective view of the working fluid filtration and separation system shown in FIG. 3;

FIG. 5 is an exploded view of an electrostatic separator of the working fluid filtration and separation system shown in FIG. 4;

FIG. 6A is a cross-sectional view of the electrostatic separator shown in FIG. 5 in a partially assembled state;

FIG. 6B is a cross-sectional view of the electrostatic separator shown in FIG. 5 in a fully assembled state;

FIG. 7A is a top perspective view of an exemplary center post isolator and high voltage electrode of the electrostatic separator shown in FIG. 5;

FIG. 7B is a plan cross-sectional view of the center post isolator shown in FIG. 7A;

FIG. 7C is an exploded perspective view of the center post isolator and high voltage electrode shown in FIGS. 7A and 7B;

FIG. 8 is a perspective cross-sectional view of the center post isolator and high voltage electrode shown in FIGS. 7A-7C;

FIG. 9 is a plan view of the high voltage electrode shown in FIG. 8;

FIG. 10 is a plan cross-sectional view of a prior art center post isolator and high voltage electrode;

FIG. 11A is a schematic view of a scaled down filtration and separation system according to one embodiment of the invention;

FIG. 11B is a schematic view of a scaled down filtration and separation system enclosed by a cabinet according to one embodiment of the invention;

FIG. 12 is a schematic view of a filtration computing configuration according to one embodiment of the invention;

FIG. 13 is a schematic view of an example visual graph configuration in which the filtration monitoring computing device displays a visual graph of the voltage level of the filtration and separation system via the user interface of the filtration monitoring computing device according to one embodiment of the invention;

FIG. 14 is a schematic view of an example threshold alert configuration that the filtration monitoring computing device displays each of the statuses via the user interface via different colors according to one embodiment of the invention;

FIG. 15 is a schematic view of an example visual graph configuration in which the filtration monitoring computing device displays a visual graph of the particle count level of the filtration and separation system via the user interface of the filtration monitoring computing device according to one embodiment of the invention; and

FIG. 16 is a front perspective view of an example working fluid filtration and separation system according to one embodiment of the invention.

### DETAILED DESCRIPTION

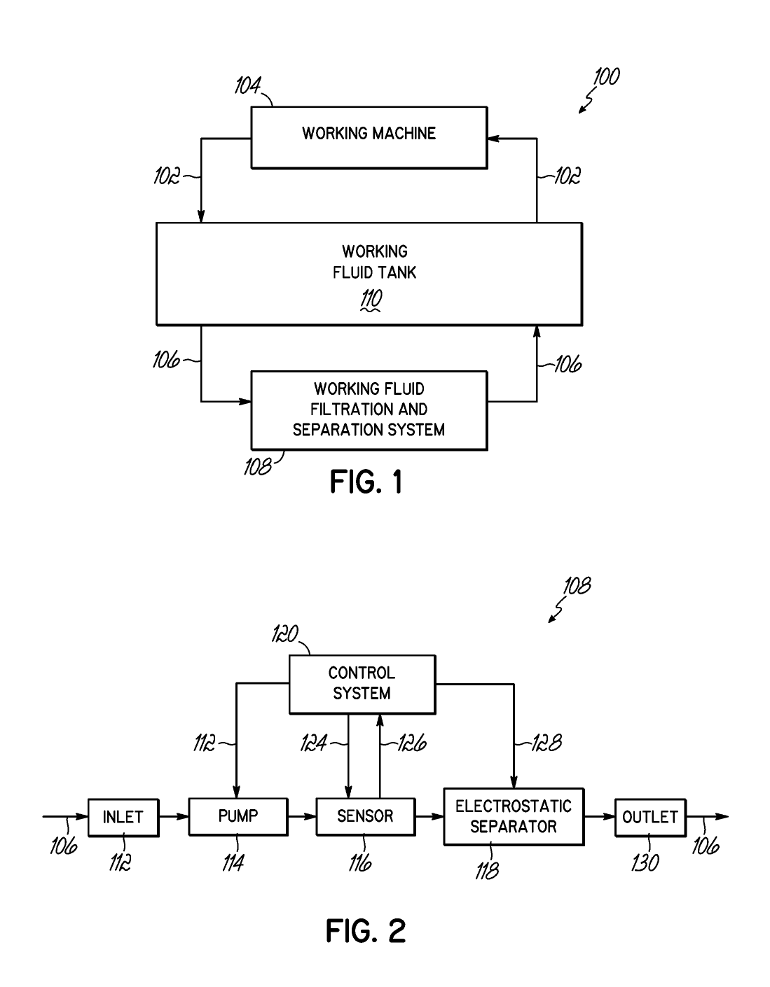

Referring now to the figures, and to FIG. 1 in particular, an exemplary fluid power system 100 is shown having a primary fluid circuit 102 providing working fluid to a working machine 104, and a secondary fluid circuit 106 providing contaminated working fluid to be cleaned to a working fluid filtration and separation system 108, according to one embodiment of the present invention. In the exemplary embodiment, fluid power system 100 includes the working machine 104, such as a hydraulically operated machine, and a working fluid reservoir or tank 110 that supplies the working fluid to the working machine 104 through the primary fluid circuit 102. The working fluid from the working machine 104 returns to the tank 110 via a drain line of the primary fluid circuit 102. In this embodiment, the fluid power system 100 includes the secondary fluid circuit 106 that circulates contaminated working fluid from the tank 110 to the working fluid filtration and separation system 108 of the present invention. As will be described in greater detail below, the working fluid filtration and separation system 108 is specifically designed to remove particulates and varnish from the working fluid contained within the tank 110.

As shown diagrammatically in FIG. 2, the working fluid filtration and separation system 108 includes in one embodiment an inlet 112 that receives the working fluid from the tank 110. The filtration and separation system 108 may include a pump 114 that circulates the working fluid received from the tank 110 through the filtration and separation system 108 so that particulates and varnish in the contaminated working fluid can be removed. According to one embodiment, the pump 114 may comprise a variable frequency drive or variable displacement pump that provides an adjustable flow rate and dwell time of the working fluid as it circulates in the filtration and separation system 108. For example, the flow rate of the working fluid may be adjusted via the variable frequency drive or variable displacement pump in a range of 3.0 to 5.0 Gallons Per Minute (GPM). Suitable variable frequency drives or variable displacement pumps for use in the present invention may include, by way of example only, Model No. 2mm1u11, commercially available from Honor located in Houston, Tex., Model No. S1, commercially available from Clark in Traverse City, Mich., and Model No. AZMF-12-011-UQR12PL, commercially available from Rexroth located in West Chester, Ohio.

According to the exemplary embodiment, the working fluid filtration and separation system 108 may further include one or more sensors 116. According to one embodiment, the sensors 116 may determine various parameters of the working fluid being circulated through the filtration and separation system 108, including the temperature, pressure, humidity and fluid flow rate of the working fluid. The sensors 116 may also determine a volume density of particulate contaminants in the working fluid and/or the presence of water in the working fluid and/or the dielectric strength of the fluid, and/or an electric charge or electric field strength of the fluid, and/or comprise an infrared sensor that determines a chemical spectrum of the working fluid to determine a condition of the fluid. Suitable sensors 116 for use in the present invention include, by way of example only, Model No. CS-1220-A-0-0-0-1/KAS, commercially available Hydac located in Sulzbach/Saar, Germany, and Model No. CS-1210-A-0-0-0-1/KAS, commercially available Hydac located in Sulzbach/Saar, Germany.

According to one aspect of the present invention, the working fluid filtration and separation system 108 includes an electrostatic separator 118, as will be described in greater detail below. The filtration and separation system 108 further includes a control system 120 that is electrically coupled to, and controls, each of the pump 114, the one or more sensors 116, and the electrostatic separator 118 fluidly connected to the pump 114. In this example, the control system 120 may apply a signal 122 to the pump 114 to control the flow rate of the working fluid circulating through the working fluid filtration and separation system 108. The control system 120 may further apply and receive signals, 124 and 126, to and from the one or more of the sensors 116, respectively. The control system 120 may further apply a signal 128 to control operation of the electrostatic separator 118. Suitable control systems 120 for use in the present invention include, by way of example only, Model No. HE-EXL1EZ, commercially available Horner located in Indianapolis, Ind., Model No. X2PRO, commercially available Beijer located in Malmoe, Sweden, and Model No. 8020, commercially available Allen Bradley, located in Milwaukee, Wis.

In the exemplary embodiment as shown in FIG. 2, the sensors 116 are shown located between the pump 114 and the electrostatic separator 118. It will be appreciated, however, that the location of one or more of the sensors 116 can be changed to any other location of the working fluid filtration and separation system 108 as may be required for measurement of a particular characteristic of the working fluid at a desired location.

According to one embodiment, the electrostatic separator 118 is controlled via the signal 128 which may be a voltage signal applied by the control system 120. In this example, the applied voltage may be a direct current voltage having a value approximately between 3 kV-12 kV, although other voltage ranges are possible as well. According to a further embodiment, the operating health of the electrostatic separator 118 may be determined by the value of the voltage signal 128 that is applied to the electrostatic separator 118.

For example, as described in detail below, a clean electrostatic separator 118 that is newly placed in service may sustain a large applied voltage having a value of approximately 12 kV. In contrast, for example, a dirty electrostatic separator 118 that has been in service for an extended period of time may only sustain an applied low voltage having a value of approximately 3 kV. In a further embodiment, the voltage that the electrostatic separator 118 may sustain may be recorded over time. Based on the time dependent measurement of voltage of the electrostatic separator 118 over time, the control system 120 may predict an expected useful lifetime of the electrostatic separator 118. The control system 120 may further provide a recommendation for a scheduled date when the electrostatic separator 118 should be serviced based on the expected useful lifetime of components of the electrostatic separator 118. According to one embodiment, based on the scheduled service date, components of the electrostatic separator 118 may be replaced or refurbished to improve the performance of the system.

According to one embodiment, the control system 120 may further control one or more of the sensors 116 that measure electrostatic charge buildup in the working fluid filtration and separation system 108 and/or in the working fluid flowing through the system 108. One exemplary sensor 116 that is suitable for measuring electrical charge in the work fluid is Model No. Stat Stick, commercially available from Hydac located in Sulzbach/Saar, Germany. The filtration and separation system 108 may further comprise anti-static filters (not shown) to remove electrostatic charge from the system 108 and/or from the working fluid flowing through the system 108.

According to one embodiment, working fluid filtration and separation system 108 includes an outlet 130 that conveys the cleaned working fluid back to the working fluid tank 110 via the secondary fluid circuit 106 (see FIG. 1).

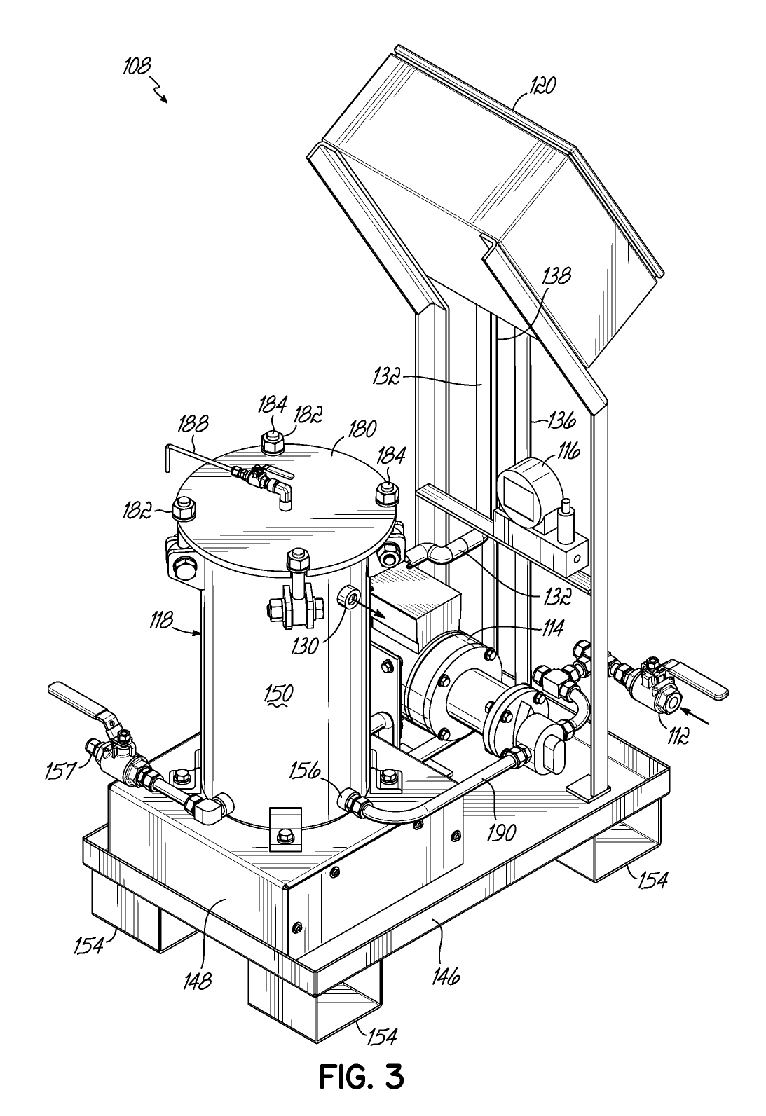

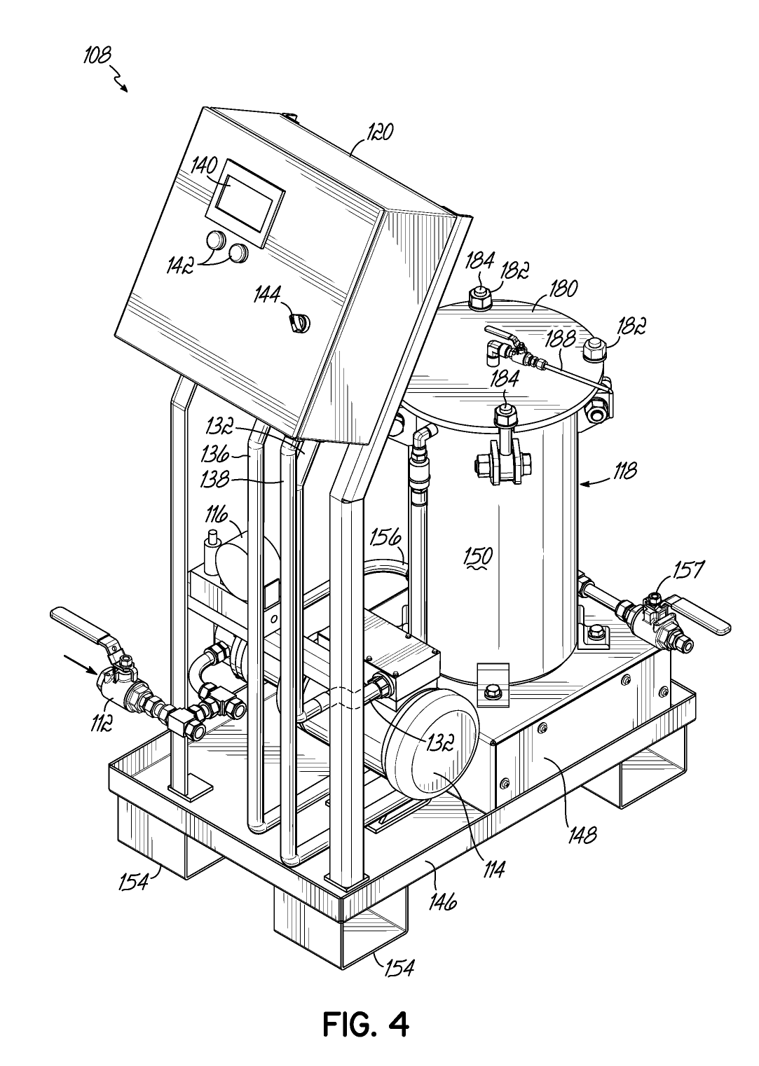

The construction of an exemplary working fluid filtration and separation system 108 is shown in FIGS. 3 and 4. In this embodiment, the filtration and separation system 108 includes the fluid inlet 112, the pump 114, the one or more sensors 116, the electrostatic separator 118, and the control system 120. The control system 120 may apply signals to the pump 114 via an electrical connection 132. The control system 120 may also apply and receive signals to and from the one or more of the sensors 116 through the electrical connection 134. The control system 120 may also control the electrostatic separator 118 by applying signals (e.g., voltages) through electrical connections 136 and 138.

According to one embodiment, the control system 120 may further include a touch screen display 140 or any other suitable human/machine interface. The control system 120 may further include one or more mechanical user input devices, such as mechanical input buttons or switches 142 and a mechanical power on/off switch 144 (see FIG. 4).

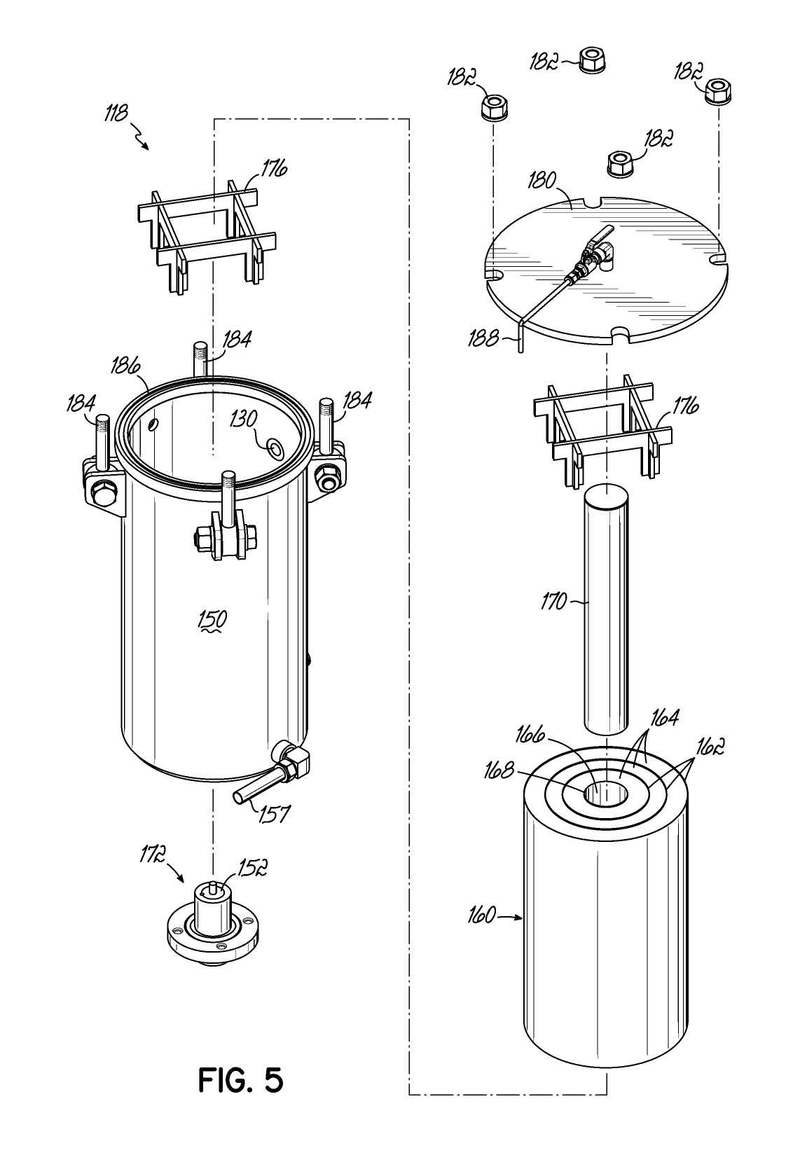

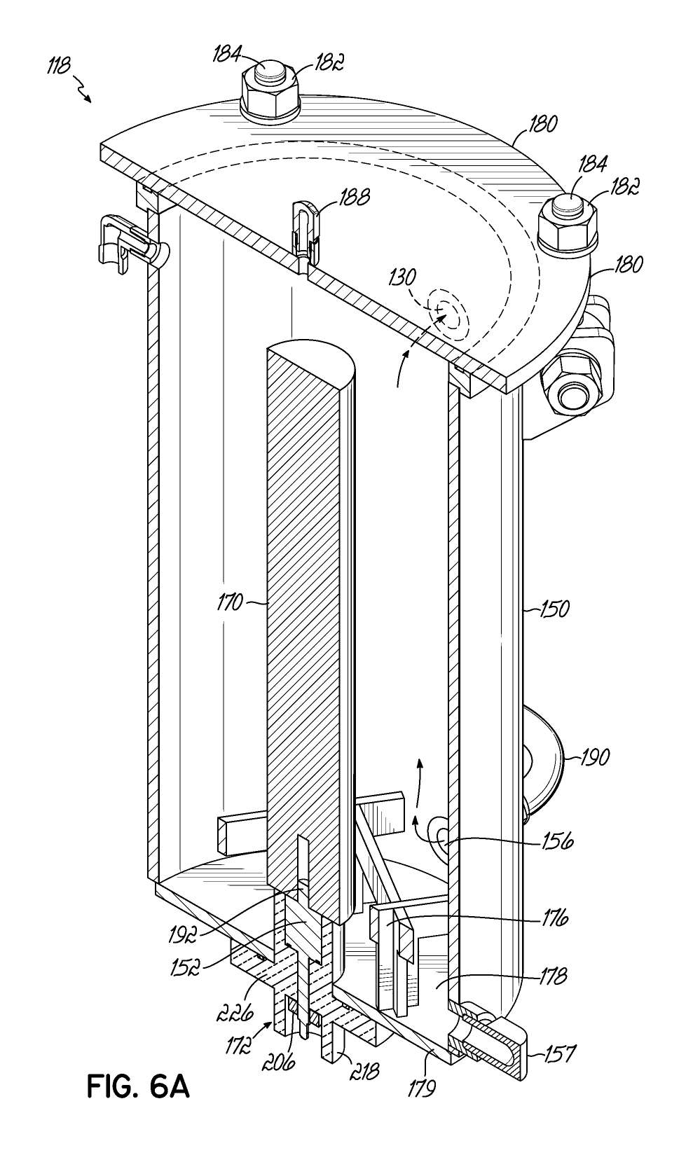

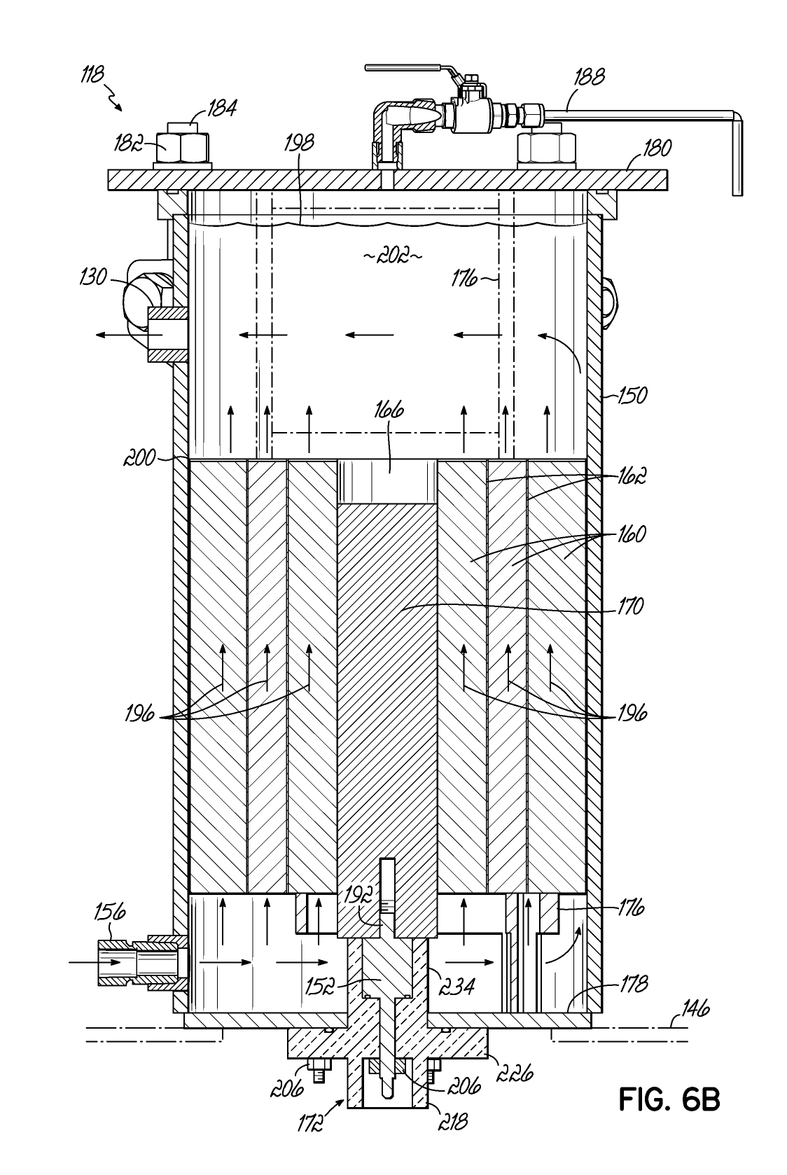

As shown in FIGS. 3 and 4, the working fluid filtration and separation system 108 may include a mechanical housing including a drip tray 146. The mechanical housing may further include a mounting platform 148 that mechanically supports a vessel 150 of the electrostatic separator 118. As described in further detail below, the mounting platform 148 provides an internal chamber in which the electrical connection 138 may be attached to a high voltage electrode 152 (FIGS. 5, 6A and 6B) of the electrostatic separator 118. The working fluid filtration and separation system 108 may be configured as a portable device. As such, the housing of the filtration and separation system 108 may include mechanical supports 154 which may be configured to accommodate lifting and moving of the filtration and separation system 108 by a forklift (not shown). In other embodiments, the housing of the filtration and separation system 108 may be provided with castors or wheels (not shown), and a handle (not shown), so that the filtration and separation system 108 may easily be wheeled from one location to another by a user.

Referring now to FIG. 5, the electrostatic separator 118 is shown according to one embodiment. In this embodiment, the electrostatic separator 118 is effective for removing insoluble materials, such as particulates and varnish, from the contaminated working fluid which may comprise hydraulic oil, for example. The particulates may be any conductive or non-conductive particulates including silica (e.g., dirt), metallic particles, plastic particulates, etc. The particulates may have sizes as small as 100 nm in diameter for example.

Referring to FIGS. 3-5, the vessel 150 of the electrostatic separator 118 is constructed of a rugged conducting material such as aluminum, steel or stainless steel. The vessel 150 may include an inlet 156 through which the contaminated working fluid from the tank 110 may enter the vessel 150. The vessel 150 may further include the outlet 130 through which the cleaned working fluid may be conveyed from the vessel 150 to the tank 110 via the secondary fluid circuit 106. A drain 157 is provided to remove working fluid from the vessel 150 as may be necessary.

In one embodiment, the vessel 150 has an outer diameter of approximately 14 inches and a height of about 24 to about 32 inches, although these dimensions may change depending upon a particular working fluid filtration and separation requirement or application.

According to one embodiment as shown in FIGS. 5 and 6B, the electrostatic separator 108 includes an electrostatic collector element 160. The electrostatic collector element 160 may include a plurality of concentric, cylindrically-shaped electrodes 162 of different radii. The electrostatic collector element 160 may further include a plurality of corrugated walls or filters 164 residing in spaces between adjacent electrodes 162. The electrostatic collector element 160 may further include a hollow cylindrically shaped space 166, defined by the inner-most cylindrical electrode 168, having a radius slightly less than the inner diameter of the inner-most cylindrically-shaped electrode 168. One exemplary electrostatic collector element 160 suitable for use in the present invention is fully described in U.S. Pat. No. 5,501,783, which is hereby incorporated herein by reference in its entirety. In one embodiment, the electrostatic collector element 160 may have an outer diameter slightly less than an inner diameter of the vessel 150, and a height in a range of about 16 inches to 24 inches.

Referring to FIGS. 5, 6A and 6B, the electrostatic separator 118 may further include a cylindrically shaped center post electrode 170. As described in greater detail below, the center post electrode 170 may be configured to be mounted along the cylindrical axis of the vessel 150. Further, the center post electrode 170 may be configured to reside within the hollow cylindrically shaped space 166 of the electrostatic collector element 160 when the electrostatic collector element 160 is installed within the vessel 150, as described in further detail below and illustrated, for example, in FIG. 6B. In one embodiment, the center post electrode 170 is made of aluminum.

According to one embodiment, the electrostatic separator 118 may further include a center post isolator 172 as shown in FIGS. 5, 6A, 6B and 7A-7C. In this example, the center post isolator 172 is configured to mechanically mount the center post electrode 170 within the vessel 150. The center post isolator 172 is configured to electrically isolate the center post electrode 170 from the vessel 150. In one embodiment, the center post isolator may be made of Delrin®, commercially available from DuPont.

The center post isolator 172 further includes the high voltage electrode 152 which may be made of aluminum. In this embodiment, the high voltage electrode 152 is configured to be mechanically and electrically connected to the center post electrode 170. The high voltage electrode 152 is further configured to be connected to a high voltage source via the control system 120 so that under operating conditions, the high voltage electrode 152 applies a high voltage from the high voltage source, via the control system 120, to the center post electrode 170.

The electrostatic collector element 160 is configured to be electrically connected to the center post electrode 170 such that every other cylindrical electrode 162 develops a high voltage while the remaining electrodes 162 are held at a ground potential common with the vessel 150 which is likewise held at a ground potential. Under operating conditions, therefore, a high voltage develops between adjacent pairs of cylindrically-shaped electrodes 162.

The electrostatic separator 108 may further include one or more electrostatic collector element supports 176. One of the electrostatic collector element supports 176 is configured to mechanically support the electrostatic collector element 160 within the vessel 150 above a bottom internal surface 178 (see FIG. 6A) of a bottom wall 179 of the vessel 150. In this example, the electrostatic separator 108 further includes a lid 180 which may be mounted on the vessel 150 to form a liquid-tight seal. A second electrostatic collector element 176 (not shown) may be mounted above the electrostatic collector element 160 and below the lid 180.

As shown in FIG. 5, the lid 180 may be mechanically mounted to the vessel 150 using mechanical fasteners, such as threaded nuts 182 which are configured to be threadably mounted onto corresponding threaded clamp bolts 184, hingedly secured to the vessel 150. The electrostatic separator 118 may further include an O-ring 186 that is configured to make a liquid-tight seal between the lid 180 and the vessel 150. The lid 180 may further include a vent 188.

As shown in FIGS. 5, 6A and 6B, the vessel 150 includes the inlet port 156 which is fluidly connected to an inlet supply line 190. In this example, the inlet supply line 190 provides the contaminated working fluid from the pump 114 to the electrostatic separator 118 to be cleaned. In this embodiment, the vessel 150 includes the outlet port 158 through which cleaned working fluid may be removed from the electrostatic separator 118 and conveyed back to the tank 110.

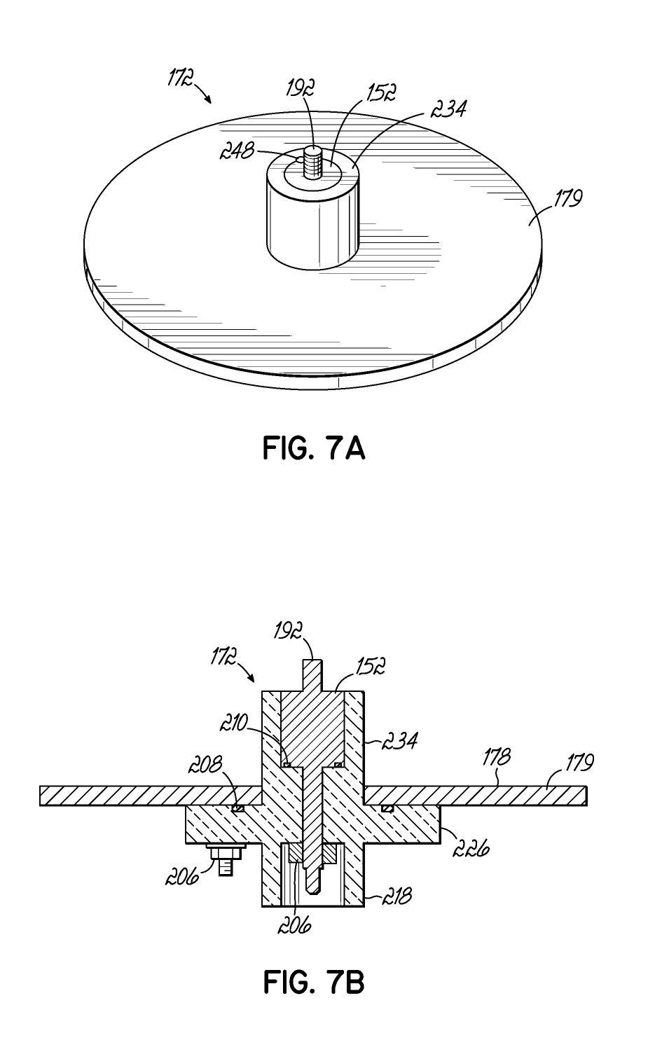

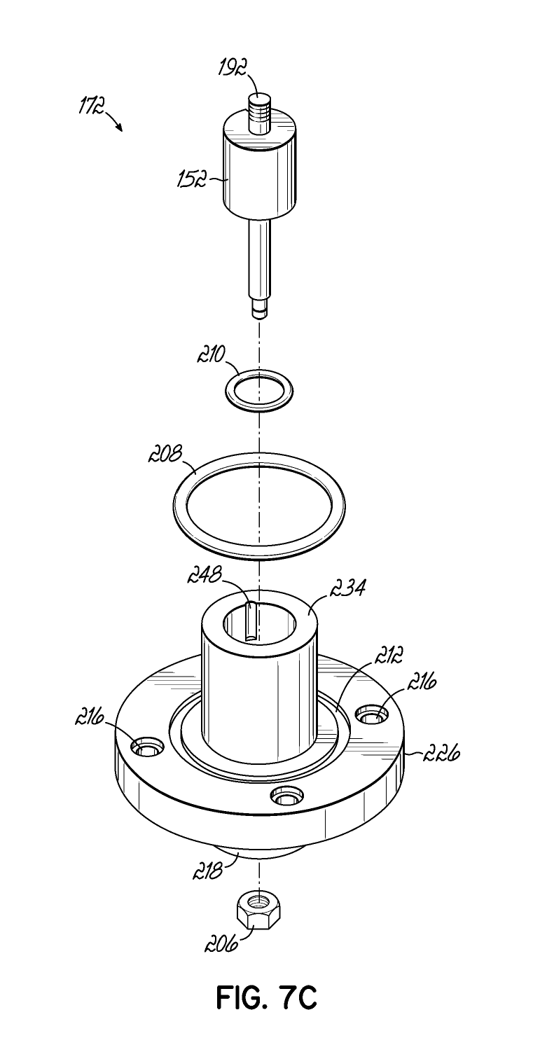

As shown in FIGS. 6B and 7A, the center post electrode 170 may be mounted to the high voltage electrode 152 via a threaded screw connection 192 described in greater detail below. In this way, the high voltage electrode 152 is electrically isolated from the vessel 150 and is mechanically mounted to the center post isolator 172 which may itself be mechanically mounted to a bottom wall 194 of the vessel 150 as shown in FIG. 7B.

As shown in the exemplary embodiment of FIGS. 6A and 6B, contaminated working fluid from the tank 110 is introduced into the vessel 150 of the electrostatic separator 118 through the inlet port 156, flows upward through the electrostatic separator 118, and is removed via the outlet port 130. In further embodiments, the contaminated working fluid may be introduced from an upper inlet port (not shown), flow downward, and be removed from a lower outlet port (not shown). Other flow patterns may be employed in further embodiments as will be readily apparent to those of ordinary skill in the art.

According to one embodiment, the electrostatic collector element 160 may be installed within the vessel 150 such that the contaminated working fluid may flow upwardly through the electrostatic collector element 160 in an axial direction 196. In this example, the center post electrode 170 is installed so as to be positioned within the hollow cylindrically shaped space 166 of the electrostatic collector element 160.

As described above, the electrostatic collector element 160 may be configured to be electrically connected to the center post electrode 170 such that every other cylindrical electrode 162 develops a high voltage while the remaining electrodes 162 are held at a ground potential common with the vessel 150 which is likewise held at a ground potential. Under operating conditions, therefore, a high voltage develops between adjacent pairs of cylindrically-shaped electrodes 162.

The high voltage established between adjacent pairs of cylindrically-shaped electrodes 162 is associated with corresponding electric fields that develop between adjacent pairs of cylindrically-shaped electrodes 162. As the contaminated working fluid flows along the axial direction 196 in the presence of the electric fields, contaminants in the working fluid are drawn by the electric fields to the electrodes 162, resulting in precipitation of contaminants on the electrodes 162. In this way, contaminants are electrostatically removed from the contaminated working fluid as it flows through the electrostatic collector element 160.

In this example, under operating conditions, a fluid level 198 typically resides above an upper level 200 of the electrostatic collector element 160, leaving a volume 202 of vapor above the fluid level 198. In this example, the vent 188 is provided in the lid 180 and is configured to allow vapor to escape the electrostatic separator 118 so that a desired pressure may be established within the vessel 150.

As shown in FIGS. 6A, 6B, 7A and 7B, the center post isolator 172 is mounted to the bottom wall 179 of the vessel 150. In one embodiment, the bottom wall 179 is a circular conducting disk having a circular hole 204 in its center. The hole 204 is just sufficiently large so that a portion of the center post isolator 172 may protrude through the bottom wall 179.

As described above, the center post isolator 172 is made of an electrically insulating material that electrically isolates the bottom wall 179 of the vessel 150 from the high voltage electrode 152. The center post isolator 172 may be mounted to the bottom wall 179 of the vessel 150 using mechanical fasteners 206. An elastic O-ring 208 may also be provided to create a liquid-tight seal between the center post isolator 172 and the bottom wall 179 of the vessel 150, as described in greater detail below. A further elastic O-ring 210 may also be provided to create a liquid-tight seal between the high voltage electrode 152 and the center post isolator 172, as also described in greater detail below.

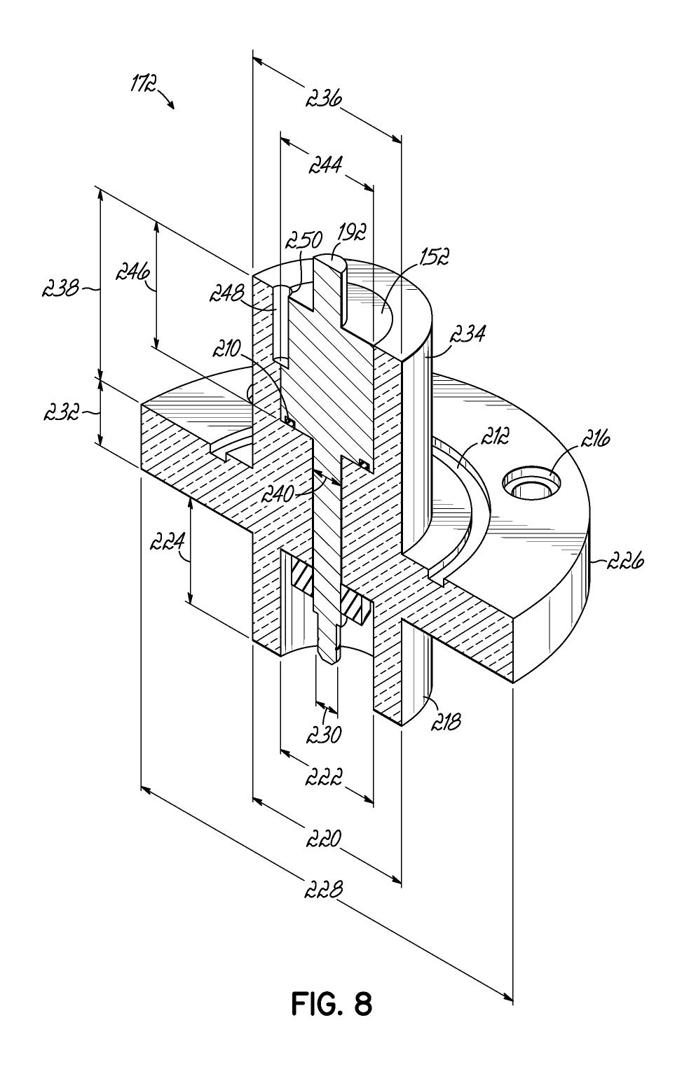

FIGS. 7B and 7C illustrate the center post isolator 172 along with elastic O-rings, 208 and 210, and the high voltage electrode 152, according to one embodiment. Elastic O-ring 208 is configured to be seated in a corresponding groove 212 of the center post isolator 172 to form a liquid-tight seal between the center post isolator 172 and the bottom wall 179 (e.g., see FIG. 7) of the vessel 150. Elastic O-ring 210 is configured to be seated in a corresponding groove 214 (e.g., shown in FIG. 7B and FIG. 8) of the center post isolator 172 to form a liquid-tight seal between the high voltage electrode 152 and the center post isolator 172. According to one embodiment, the center post isolator 172 may further include holes 216 configured to accommodate mechanical fasteners (e.g., fasteners 206 illustrated in FIGS. 7B and 7C) to mount the center post isolator 172 to the bottom wall 179 (e.g., see FIG. 7B) of the vessel 150.

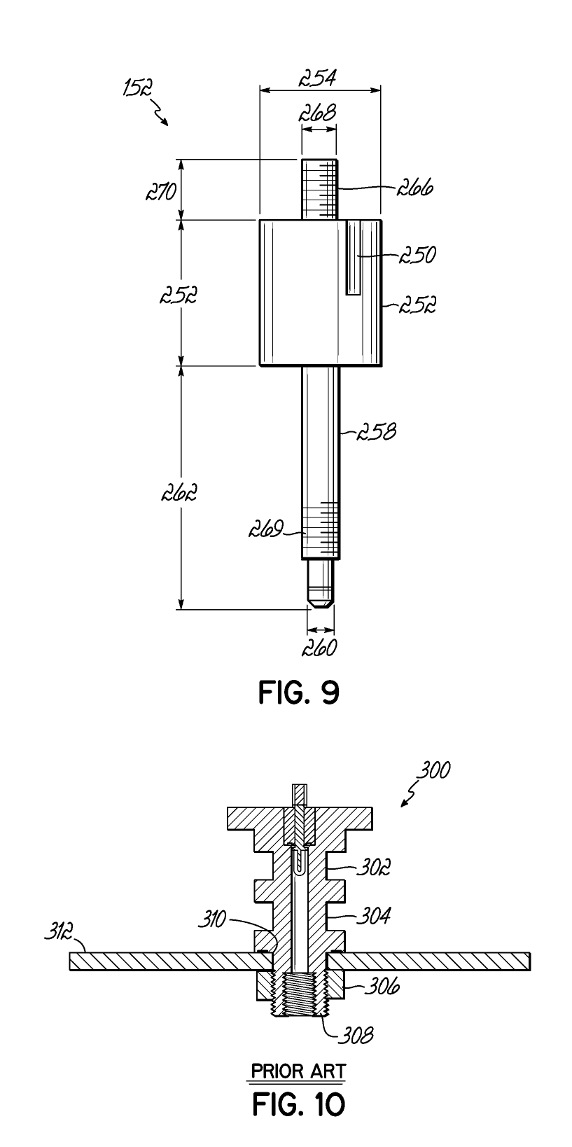

FIGS. 8 and 9 illustrate an exemplary embodiment of the center post isolator 172 and high voltage electrode 152. In this embodiment, the center post isolator 172 includes a first cylindrically shaped shell structure 218 having a first outer diameter 220, a first inner diameter 222, and a first height 224. In this example, the center post isolator 172 further includes a cylindrically shaped disk region 226 having a second outer diameter 228, a second inner diameter 230, and a second height 232, wherein the second outer diameter 228 is larger than the first inner diameter 222, and the second inner diameter 230 is smaller than the first inner diameter 222.

The center post isolator 172 further includes a second cylindrically shaped shell structure 234 having a third outer diameter 236, and a third height 238. According to this embodiment, the third outer diameter 236 has a value approximately equal to the first outer diameter 220. Further, in this example, the second cylindrically shaped shell structure 234 has a third inner diameter 240 that varies with height. For example, the second cylindrically shaped shell structure 234 may have a third inner diameter 240 for a fourth height 242, and a fourth inner diameter 244 for a fifth height 246. According to one embodiment, the third inner diameter 240 may have a value approximately equal to the second inner diameter 230. Further, in this example, the fourth inner diameter 244 may have a value approximately equal to the first inner diameter 222.

As shown in FIGS. 7C and 8, the center post isolator 172 may further include a cylindrical notch “keyway” 248 to accommodate a corresponding cylindrically shaped key (not shown) to prevent rotation of the high voltage electrode 152 with respect to the center post isolator 172. In this example, the high voltage electrode 152 also includes a corresponding notch 250 (FIG. 8) that engages with the corresponding key, as would be readily apparent to persons of ordinary skill in the art.

The following example provides specific values for the various dimensions of the center post isolator 172 according to an exemplary embodiment. According to one embodiment, first outer diameter 220 may have a value given by DO₁≈2 in, the first inner diameter 222 may have a value given by DI₁≈1.25 in, and the first height 224 may have a value given by H₁≈1.25 in. Further, the second outer diameter 228 may have a value given by DO₂≈5 in, the second inner diameter 230 may have a value given by DI₂≈0.375 in, and the second height 232 may have a value given by H₂≈0.75 in. According to an embodiment, the third outer diameter 236 may have a value given by DO₃≈2 in, and the third height 238 may have a value given by H₃≈2.25 in. In this example, the third inner diameter 240 may have a value given by DI₃≈0.375 in, the fourth height 242 may have a value given by H₄≈0.75 in, the fourth inner diameter 244 may have a value given by DI₄≈1.25 in, and the fifth height 246 may have a value given by H₅≈1.5 in.

Referring now to FIG. 9, the high voltage electrode 152 is shown according to an exemplary embodiment. In this embodiment, the high voltage electrode 152 is a removable electrical conductor that is configured to be at least partially mounted within a central void region formed within the cylindrical spaces defined by the inner diameters DI₁, DI₂, DI₃, and DI₄, (e.g., see, 222, 230, 240 and 244) of the center post isolator 172 (see FIG. 9).

According to one embodiment, the high voltage electrode 152 may further include a first solid conducting cylindrically shaped region 252 having an outer diameter 254 with a value given by DC₁≈DI₄, and a height 256 having a value HC₁≈H₅. The first solid conducting cylindrically shaped region 252 is configured to fit within an internal void region of the center post isolator 172 defined by DI₄ and H₅ of the center post isolator 172 (see FIG. 9).

According to an embodiment, the high voltage electrode 152 may further include a second solid conducting cylindrically shaped region 258 having an outer diameter 260 with a value given by DC₂≈DI₂≈DI₃, and a height 262 having a value given by HC₂. The second solid conducting cylindrically shaped region 258 is configured to fit within the internal void region defined by DI₁, DI₂, DI₃, H₁, H₂, and H₄ of the center post isolator 172, wherein HC₂<H₁+H₂+H₄. The second solid conducting cylindrically shaped region 2588 further includes a threaded portion 269 configured to make a mechanical and electrical connection with an electrical voltage source as described above.

According to one embodiment, the high voltage electrode 152 may further include a threaded solid conducting cylindrically shaped region 266 having an outer diameter 268 with a value given by DC₃≈DC₂, and a height 270 having a value given by HC₃. The threaded solid conducting cylindrically shaped region 266 may be configured to extend from H₁+H₂+H₃ to H₁+H₂+H₃+HC₃ when the high voltage electrode 152 is housed within the central void region of the center post isolator 172. Further, the threaded conducting region 266 is configured to make a mechanical and electrical connection with the center post electrode 170 as described above.

FIG. 10 illustrates a known conventional center post isolator 300 that suffers from potential mechanical weakness and is prone to fracture. The center post isolator 300 suffers from the drawback that it has structural weak points that serve as stress concentration points. Under operating conditions, over time, stress concentration in weak points 302 and 304 leads to fracture and mechanical failure.

The center post isolator 300 is mounted using a thin wall nut 306 to secure a threaded portion 308 of the center post isolator 300 that protrudes through a hole 310 of a bottom wall 312 of the vessel 314. Stress concentration in the thin wall nut 306 and threaded portion 308 also has the potential to lead to fracture and mechanical failure of the center post isolator 306.

In contrast, as illustrated in FIGS. 6, 7A, 7B, 8, and 9, the center post isolator 172 of the present invention has a robust construction that does not exhibit stress concentration points. For example, the center post isolator 172 of the present invention includes the cylindrically shaped disk region 226 that distributes stress over a larger area to reduce the occurrence of stress concentration points. Further, the center post isolator 172 of the present invention is mounted to the bottom wall 179 of the vessel 150 by robust mechanical fasteners 216 providing a stronger and more secure mounting than the comparatively weaker mounting of the center post isolator 300 that is mounted using a thin wall nut 306.

Further, the center post isolator 172 of the present invention provides a more secure liquid-tight seal due to the presence of the elastic O-ring 208. In contrast, over time during operation, the center post isolator 300 may suffer material degradation leading to leakage of the working fluid through mechanical cracks and flaws that develop in the center post isolator 300.

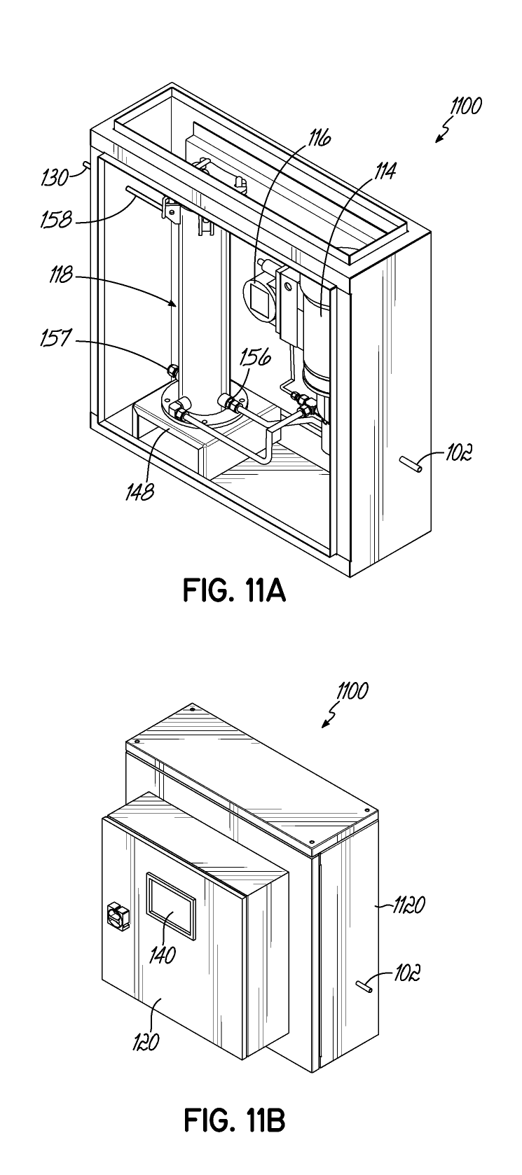

FIGS. 11A and 11B illustrate a scaled down filtration and separation system 1100 in which embodiments of the present invention, or portions thereof, may be implemented. In an embodiment, the working fluid filtration and separation system 108 may be scaled down into a smaller configuration as shown with the scaled down filtration and separation system 1100. The filtration and separation system 108 may be used in association with a large working machine 104 where significantly large amounts of fluid are being flushed through the working fluid tank 110 as the large working machine 104 operates. The significantly large amounts of fluid are then flushed through the filtration and separation system 108 such that the filtration and separation system 108 removes the varnish and/or unwanted particles from the fluid. In order for the filtration and separation system 108 to filter the large amounts of fluid flushed by the working machine 104, the filtration and separation system 108, itself, may occupy a large footprint to accommodate the large amounts of fluid that is to be filtered. For example, the filtration and separation system 108 may be able to filter fluid at a rate of 3.0 to 5.0 Gallons per Minute (GPM) and may be capable of removing varnish and/or unwanted particles from thousands of gallons of fluid that is associated with up to and/or above a 6,000 gallon working fluid tank 110.

However, for many applications, such a large work fluid filtration and separation system 108 is unnecessary as many applications may have working machines 104 that require significantly less fluid to operate. In such applications, applying a working fluid filtration and separation system 108 that is capable of filtering significantly large amounts of fluid may be an unnecessary devotion of power and/or space resources. Rather than incorporating a large filtration and separation system 108 that occupies a significantly large space and requires a significant amount of electricity to reach the large voltage levels to generate the electrostatic fields that are capable of removing the varnish and/or unwanted particles from the large amounts of fluid, a scaled down version of the filtration and separation system 108 may be incorporated.

A scaled down version of the working fluid filtration and separation system 108, such as the scaled down filtration and separation system 1100, may execute in a similar manner as the large version of the filtration and separation system 108 but may do so while occupying significantly less space as the large filtration and separation system 108 as well as requiring significantly less electricity. The scaled down filtration and separation system 1100 may be applied to smaller applications that have working machines 104 with smaller fluid tanks 110 that simply require less fluid to operate. With less fluid flushed through by the operation of the working machine 104, the scaled down filtration and separation system 1100 may require less space due to less fluid having to be filtered by the scaled down filtration and separation system 1100.

Further, weaker electrostatic fields may be required to adequately remove the varnish and/or unwanted particles from significantly less fluid flowing through the scaled down working fluid filtration and separation system 1100 thus requiring lower voltage levels to generate the weaker electrostatic fields and as a result requiring less electricity to power. Additionally, the scaled down filtration and separation system 1100 may be less expensive and may be easier to install and maintain as compared to the large filtration and separation system 108. In scaling down the large filtration and separation system 108 to the scaled version, the flow rates and the electrostatic cleaning parameters of the large filtration and separation system 108 may be preserved but decreased in scale as compared to the flow rates and the electrostatic cleaning parameters of the large filtration and separation system 108.

For example, a molding machine (not shown) may have a 400 to 500 gallon working fluid tank 110 as compared to a 5,000 to 6,000 gallon working fluid tank 110 for significantly larger applications. The molding machine having a 400 to 500 gallon working fluid tank 110 may experience flow rates of fluid being flushed by the molding machine at 1.5 GPM to 2.5 GPM while the working machine 104 having the 5,000 to 6,000 gallon working fluid tank 110 may have flow rates of fluid at 3.0 GPM to 5.0 GPM. In scaling down the large filtration and separation system 108 to the scaled down filtration and separation system 1100 for the molding machine, the electrostatic cleaning parameters as determined for the flow rate of 3.0 GPM to 5.0 GPM for the large filtration and separation system 108 may be decreased in scale to accommodate the 1.5 GPM to 2.5 GPM flow rate for the molding machine.

Incorporating the large filtration and separation system 108 to filter the fluid of the molding machine may adequately remove the varnish and/or unwanted particles from the fluid of the molding machine but such a large filtration and separation system 108 may be unnecessary to adequately remove the varnish and/or unwanted particles from the fluid due to the significantly less amount of fluid flushed by the molding machine. Thus, a scaled down filtration and separation system 1100 that occupies significantly less space and requires significantly less electricity may be applied to the molding machine and still adequately remove the varnish and/or unwanted particles of the fluid flushed by the molding machine.

As noted above, the scaled down filtration and separation system 1100 may occupy significantly less space than the large filtration and separation system 108. In an embodiment, the scaled down filtration and separation system 1100 may be mounted in a cabinet where the scaled down filtration and separation system 1100 is enclosed by a cabinet 1120. The cabinet 1120 may be positioned adjacent to, or attached to, the working machine 104 such that the scaled down filtration and separation system 1100 adequately removes the varnish and/or unwanted particles from the fluid flushed by the working machine 104. Often times, the working machine 104 may operate in dirty environments. Mounting the scaled down filtration and separation system 1100 in the cabinet 1120 protects the scaled down filtration and separation system 1100 from dirt as well as damage that the scaled down filtration and separation system 1100 may otherwise be exposed to if not protected by the cabinet.

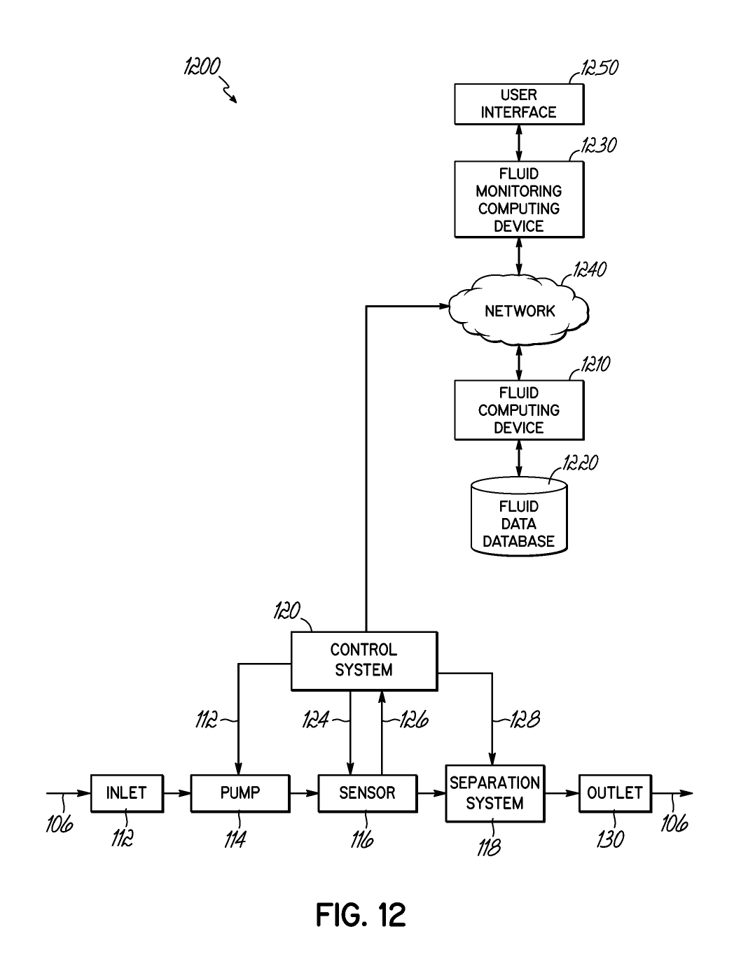

FIG. 12 illustrates a filtration computing configuration 1200 in which embodiments of the present invention, or portions thereof, may be implemented. The filtration computing configuration 1200 includes the working fluid filtration and separation system 108 as discussed in detail in FIG. 2, a filtration computing device 1210, a fluid data database 1220, a filtration monitoring computing device 1230, and a network 1240. The filtration monitoring computing device 1230 includes a user interface 1250.

In one embodiment of the present invention, the filtration computing device 1210 may communicate with the control system 120 to obtain filtration data generated from the monitoring of the characteristics of fluid flowing through the filtration and separation system 108 by the control system 120. The filtration computing device 1210 may then analyze the filtration data to generate different types of analytics of the filtration and separation system 108, such as whether a characteristic has exceeded a threshold, that provide insight that is easily understandable by a user as to the performance of the filtration and separation system 108. The filtration computing device 1210 may then communicate the analytics of the filtration and separation system 108 to a filtration monitoring computing device 1230 that is operated by the user so that the user may monitor the performance of the filtration and separation system 108 via the analytics provided to the user via the filtration monitoring computing device 1230.

The control system 120 includes a microprocessor, a memory and a network interface and may be referred to as a computing device or simply “computer”. In one embodiment of the present invention, multiple modules may be implemented on the same computing device. Such a computing device may include software, firmware, hardware, or a combination thereof. Hardware can include but is not limited to, a microprocessor and/or a memory.

As the control system 120 monitors the filtration data for each characteristic of the fluid flow of the filtration and separation system 108, the control system 200 may store the filtration data in the filtration data database 1220 via the network 1240. In an embodiment, each sensor that provides a signal to the control system 120 may have an Internet Protocol (IP) address associated with each particular sensor. The control system 120 may then stream the filtration data that is measured by each sensor for each characteristic that is monitored by the control system 120 via network 1240 and then stores the filtration data in the filtration data database 1220 based on the IP address of the filtration data.

The filtration computing configuration 1200 may include one or more working fluid filtration and separation systems 108 in which each filtration and separation system 108 is associated with a control system 120 that is monitoring the filtration of the filtration and separation system 108. Thus, the filtration computing configuration 1200 may also include one or more control systems 120 dependent on the quantity of filtration and separation systems 108 included in the filtration computing configuration 1200. Each control system 120 may then stream filtration data for each characteristic specific to the filtration of the filtration and separation system 108 that each control system 120 is monitoring via network 1240 to and store the filtration data in the filtration data database 1220.

For example, the filtration computing configuration 1200 may include a large factory that includes hundreds of working fluid filtration and separation systems 108. Each of the filtration and separation systems 108 that are active in the factory are associated with a control system 120 in which each individual control system 120 monitors the filtration data for each of the characteristics of the filtration flow for that specific filtration and separation system 108. Each of the control systems 120 stream filtration data for the characteristics specific to each individual filtration and separation system 108 and stores the filtration data specific to each filtration and separation system 108 included in the factory in the filtration data database 1220.

The filtration computing device 1210 includes a processor, a memory, and a network interface, herein after referred to as a computing device or simply “computer”. For example, the filtration computing device 1210 may include a data information system, data management system, web server, and/or file transfer server. The filtration computing device 1210 may also be a workstation, mobile device, computer, cluster of computers, set-top box or other computing device. In an embodiment, multiple modules may be implemented on the same computing device. Such a computing device may include software, firmware, hardware, or a combination thereof. Software may include one or more applications on an operating system. Hardware can include, but is not limited to, a processor, memory, and/or graphical user interface display. The filtration computing device 1210 may be coupled to the control system 120 and/or coupled to the filtration and separation system 108. The filtration computing device 1210 may also be positioned remote from the control system 120 and/or the filtration and separation system 108.

As the filtration computing device 1210 generates the analytics of the filtration based on the filtration data, the filtration computing device 1210 may query the filtration data database 1220 for the filtration data associated with the characteristics that the filtration monitoring device 1210 is to generate based on the IP address associated with the filtration data. For example, the filtration computing device 1210 may retrieve the filtration data associated with the voltage sensor to generate the analytics of the voltage level of the filtration and separation system 108 based on the IP addresses associated with the filtration data measured by the voltage sensor. The filtration computing device 1210 may generate the analytics of the filtration for each of the filtration and separation systems 200 included in the filtration computing configuration 1200.

The filtration monitoring computing device 1230 includes a processor, a memory, and a network interface, herein after referred to as a computing device or simply “computer.” For example, the filtration monitoring computing device 1230 may be a workstation, mobile device, computer, cluster of computers, or other computing device. In an embodiment, multiple modules may be implemented on the same computing device. Such a computing device may include software, firmware, hardware, or a combination thereof. Software may include one or more applications on an operating system. Hardware can include, but is not limited to, a processor, memory, and/or graphical user interface display.

The user interface 1250 may provide a user the ability to interact with the filtration monitoring computing device 1230. The user interface 1250 may be any type of display device including but not limited to a touch screen display, a liquid crystal display (LCD) screen, and/or any other type of display that will be apparent from those skilled in the relevant art(s) without departing from the spirit and scope of the present disclosure.

The filtration monitoring computing device 1230 may be a computing device that is accessible to the user that is monitoring the performance of the filtration and separation system 108. The filtration computing device 1210 may stream the analytics to the filtration monitoring computing device 1230 via network 1240 and the filtration monitoring computing device 1230 may display the analytics via the user interface 1250. The filtration computing device 1210 may be a stationary computing device and positioned in an office in which the user may monitor the analytics provided by the filtration computing device 1210 for the filtration and separation system 108. The filtration computing device 1210 may also be a mobile device in which the user may be able to monitor the analytics for the filtration and separation system 108 as the user changes locations.

The filtration monitoring computing device 1230 may display the analytics via the user interface 1250 streamed by the filtration computing device 1210 for each of the working fluid filtration and separation systems 108 in which the filtration computing device 1210 has generated analytics. For example, the filtration computing configuration 1200 includes a factory with hundreds of filtration and separation systems 108. The filtration monitoring computing device 1230 may display the analytics for each of the several filtration and separation systems 108 included in the filtration computing configuration 1200 such that the user may monitor the performance of each of the filtration and separation systems 200 simultaneously. The filtration monitoring computing device 1230 may also provide further analytics specific to a single filtration and separation system 108 included in the filtration computing configuration 1200 when the user requests to focus in on the analytics for a single filtration and separation system 108 that is of interest to the user.

Wireless communication may occur via one or more networks 1240 such as the internet. In some embodiments of the present invention, the network 1240 may include one or more wide area networks (WAN) or local area networks (LAN). The network may utilize one or more network technologies such as Ethernet, Fast Ethernet, Gigabit Ethernet, virtual private network (VPN), remote VPN access, a variant of IEEE 802.11 standard such as Wi-Fi, and the like. Communication over the network 1240 takes place using one or more network communication protocols including reliable streaming protocols such as transmission control protocol (TCP). These examples are illustrative and not intended to limit the present invention. Wired connection communication may occur with but is not limited to a fiber optic connection, a coaxial cable connection, a copper cable connection, and/or any other direct wired connection that will be apparent from those skilled in the relevant art(s) without departing from the spirit and scope of the present disclosure.

As noted above, the control system 120 may monitor different characteristics of the filtration for the filtration and separation system 108. The control system 120 may then provide filtration data generated from the monitoring of the characteristics of the filtration by the control system 120 to the filtration computing device 1210. The filtration data is a significant amount of data generated from the monitoring of the characteristics of the filtration over time that is incorporated by the filtration computing device 310 to determine different types of analytics for the filtration and separation system 108. For example, the filtration data includes the voltage level of the filtration and separation system 108 as monitored by the control system 120 for each filtration cycle of the filtration and separation system 108 from when the filtration and separation system 108 was first commissioned to the current moment when the user is observing the performance of the filtration and separation system 108 as provided by the filtration computing device 1210.

Analytics of the filtration and separation system 108 that may be generated by the filtration computing device 1210 incorporate the filtration data for each characteristic as monitored by the control system 120 and from the filtration data to provide insight to the performance of the filtration and separation system 108 that is easily understood by the user. The amount of filtration data monitored by the control system 120 and provided to the filtration computing device 1210 may be immense. For example, the filtration and separation system 108 may operate for significant portions of each day and may only be taken offline for short periods of time in a given year. Thus, the amount of filtration executed by the filtration and separation system 108 may be significant as the filtration and separation system 108 operates continuously for significant periods of time resulting in an immense amount of filtration data for each characteristic that is monitored by the control system 120.

Such an immense amount of filtration data monitored by the control system 120 and stored in the filtration data database 1220 may be extremely difficult for the user to parse through to obtain an assessment of the performance of the filtration and separation system 108. However, the filtration computing device 1210 may analyze the immense amount of filtration data and provide meaningful analytics that provide insight as to the performance of the filtration and separation system 108 that are easily understood by the user. For example, the filtration computing device 1210 may generate an analytic that presents the characteristic of the voltage level of the filtration and separation system 108 to the user in an easily understandable manner. The voltage level of the filtration and separation system 108 may be an indicator as to the filtration capabilities of filtration and separation system 108. As the amount of voltage increases, the likelihood that the performance of the filtration and separation system 108 is decreasing also increases. Thus, the user may easily identify the performance status of the filtration and separation system 108 based on the voltage level of the filtration and separation system 108.

The filtration computing device 1210 may incorporate the filtration data as monitored by the control system 120 for a particular characteristic of the filtration into an analytic such as a visual graph that depicts how the characteristic of the voltage level deviates over an extended period of time. Rather than the user having to parse through an immense amount of filtration data to assess the performance of the filtration and separation system 108, the filtration computing device 1210 incorporates the filtration data into an easily understood visual graph that provides insight to the user with regards to the performance of the filtration and separation system 108.

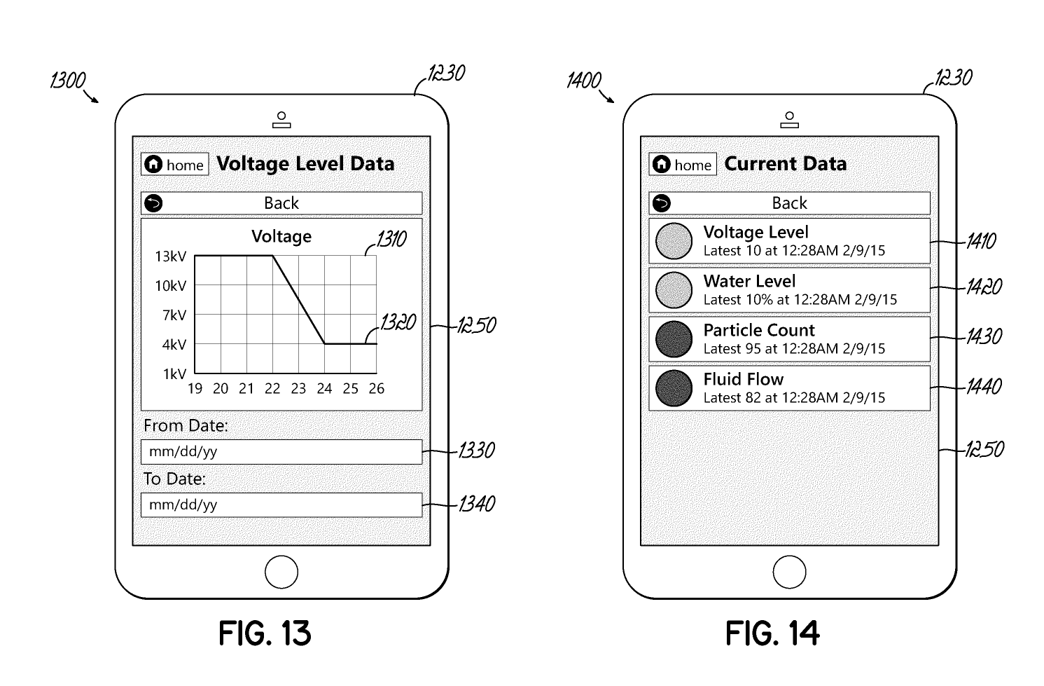

For example, FIG. 13 depicts an example visual graph configuration 1300 in which the filtration monitoring computing device 1230 displays a visual graph of the voltage level of the filtration and separation system 108 via the user interface 1250 of the filtration monitoring computing device 1230. As noted above, the voltage level of the filtration and separation system 108 may provide meaningful insight as to the performance of the filtration and separation system 108. The voltage level may be the voltage level of the electrostatic fields generated by the filtration and separation system 108 at a given moment and/or period of time in order to remove the varnish and/or other unwanted particles from the fluid that is flowing through the filtration and separation system 108.

Typically, a filtration and separation system 108 generates electrostatic fields at a maximum voltage level. The maximum voltage level may be predetermined as the voltage level necessary to generate an electrostatic field of sufficient strength to adequately remove the varnish and/or other unwanted particles from the fluid that is flowing through the filtration and separation system 108. The maximum voltage level may be predetermined based on the characteristics of the fluid that is to be cleaned by the filtration and separation system 108. For example, the maximum voltage level may be determined based on characteristics of the fluid such as but not limited to the conductivity of the fluid, the water level of the fluid, the dirt level of the fluid, the dielectric strength of the fluid, and/or any other characteristic of the fluid that may have an impact on the voltage level necessary to adequately remove the varnish and/or unwanted particles of the fluid that will be apparent to those skilled in the relevant art(s) without departing from the spirit and scope of the disclosure.

The initial maximum voltage level of the electrostatic fields generated by the filtration and separation system 108 may initially be a significantly high voltage level such as 12 kV to 15 kV in order to have electrostatic fields of adequate strength to adequately remove the varnish and/or unwanted particles from the fluid flowing through the filtration and separation system 108. The initial maximum voltage level of electrostatic fields may be any voltage level necessary to generate electrostatic fields of adequate strength to adequately remove the varnish and/or unwanted particles from the fluid flowing through the filtration and separation system 108 that will be apparent to those skilled in the relevant art(s) without departing from the spirit and scope of the disclosure.

As the filtration and separation system 108 operates over significant periods of time where the filtration and separation system 108 generates the electrostatic fields over significant periods of time as the filtration and separation system 108 removes varnish and/or unwanted particles from the fluid flowing through the filtration and separation system 108, the collector element 160 of the filtration and separation system 108 may collect the varnish and/or unwanted particles. As the amount of varnish and/or unwanted particles captured by the collector element 160 increases, the conductivity of the collector element 160 may also increase. As the conductivity of the collector element 160 decreases, the voltage level of the electrostatic fields generated by the filtration and separation system 108 may decrease.

For example, a collector element 160 initially inserted into the filtration and separation system 108 that is clean, dry, and new may initially generate electrostatic fields at voltage levels that are the maximum voltage levels generated by the power supply associated with the filtration and separation system 108, such as 12 kV to 15 kV. As the fluid flows through the filtration and separation system 108, the electrostatic fields of the collector element 160 capture the varnish and/or unwanted particles from the fluid flowing through the filtration and separation system 108. As the amount of varnish and/or unwanted particles captured by the collector element 160 increases and the collector element 160 becomes dirtier, the voltage level of the electrostatic fields of the collector element 160 decreases. Eventually, the collector element 160 may have collected a level of varnish and/or unwanted particles in which the collector element 160 is no longer effective in removing additional varnish and/or unwanted particles from the fluid flowing through the filtration and separation system 108.

The voltage level of the electrostatic fields of the collector element 160 may then be indicative as to the effectiveness of the collector element 160 in adequately removing the varnish and/or unwanted particles from the fluid flowing through the filtration and separation system 108. As the voltage level of the electrostatic fields 408 decrease, the electrostatic fields of the collector element 160 decrease and once a threshold level that the electrostatic fields of the collector element 160 has fallen below, the collector element 160 may no longer be adequately removing the varnish and/or unwanted particles from the fluid flowing through the filtration and separation system 108. Eventually, the voltage level of the electrostatic fields may decrease below a threshold where the electrostatic fields of the collector element 160 no longer remove the varnish and/or the unwanted particles from the fluid flowing through the filtration and separation system 108.

For example, the voltage level of the electrostatic fields may decrease below 3.0 kV. At that point, the voltage level of the electrostatic fields that decreases below 3.0 kV and may no longer adequately remove the varnish and/or unwanted particles from the fluid flowing through the filtration and separation system 108. At that point, the filtration and separation system 108 may continue to apply a voltage to the electrostatic fields 408 of the collector element but such applied voltage is an unnecessary use of power as the collector element 160 may no longer be removing the varnish and/or the unwanted particles from the fluid flowing through the filtration and separation system 108 and the filtration and separation system 108 is simply operating unnecessarily.

As the voltage level of the electrostatic fields decreases below the threshold level, such a dip below the threshold level may be an indication that the collector element 160 should be inspected and/or replaced as having collected an excess of varnish and/or unwanted particles. Thus, as the voltage level of the electrostatic fields generated by the filtration and separation system 108 decreases, the performance of the filtration and separation system 108 may also be decreasing. In an embodiment, the voltage level may be measured via a voltage sensor positioned on a voltage power supply associated with the filtration and separation system 108 that supplies the voltage to the electrostatic fields of the collector element 160. The voltage level may be measured via a voltage sensor positioned anywhere in the filtration and separation system 108 in order to adequately measure the voltage level of the electrostatic fields of the collector element 160 that will be apparent to those skilled in the relevant art(s) without departing from the spirit and scope of the disclosure.

The example visual graph configuration 1300 depicted in FIG. 13 depicts how the voltage level of the electrostatic fields of the filtration and separation system 108 has deviated over a period of time. As can be seen in FIG. 13, the user interface 1250 of the filtration monitoring computing device 1230 depicts a visual graph 1310 for the filtration and separation system 108 during a continuous operation of the filtration and separation system 108 as the filtration and separation system 108 filters the fluid from the reservoir 104 that is supplied to the working machine 104 as the working machine 104 operates and the filtration and separation system 108 removes the varnish and/or unwanted particles from the fluid as the working machine 104 operates.

The voltage level begins at an upper value on the plot 1320 during the initial stages of the collector element 160 as the filtration and separation system 108 initially begins filtering the fluid from the reservoir 104 that is supplied to the working machine 104 as the working machine 104 operates. As noted above, the initial voltage level of the electrostatic fields generated by the filtration and separation system 108 may be a significantly high voltage level such as 13 kV depending on the fluid that is being filtered by the filtration and separation system 108. As the collector element 160 continues over time to collect varnish and/or unwanted particles from the fluid flowing through the filtration and separation system 108 as the working machine 104 operates, the conductivity of the electrostatic fields of the collector element 160 increases and the voltage level of the electrostatic fields gradually decreases.

Eventually, the collector element 160 collects a level of varnish and/or unwanted particles in which the collector element 160 may no longer be effective in removing the varnish and/or unwanted particles from the fluid flowing through the filtration and separation system 108. At this point, the voltage level of the electrostatic fields may have decreased below a voltage level such as 4.0 kV depending on the fluid that is being filtered by the filtration and separation system 108 that is indicative that the collector element 160 is no longer effective in removing varnish and/or unwanted particles from the fluid flowing through the filtration and separation system 108. Once the voltage level of the electrostatic fields dips below the voltage level in which the collector element 160 is no longer effective in removing varnish and/or unwanted particles from the fluid, the collector element 160 should be replaced and/or inspected.

The visual graph configuration 1300 depicts the voltage level of the electrostatic fields generated by the filtration and separation system 108 for the entire duration that the filtration and separation system 108 has filtered the fluid from the working machine 104 as the working machine 104 operates. The user may request that the voltage level generated by the filtration computing device 1210 and depicted by the visual graph 1310 displayed by the user interface 1250 may cover a period of time as specified by the user. For example, the user may identify an initial time period 1330 in which the user requests the filtration computing device 1310 to generate the voltage level of the electrostatic fields generated by the filtration and separation system 108 as well as the final time period 1340. The filtration computing device 1310 may then generate the voltage level of the electrostatic fields based on the filtration data monitored by the control system 120 for that period of time and incorporated into the voltage level determination by the filtration computing device 1210 for that period of time. Thus, the user may customize the period of time in which the visual graph 1310 depicts the voltage level of the electrostatic fields generated by the filtration and separation system 108.

The visual graphs of characteristics and/or analytics of filtration that may be generated by the filtration computing device 1210 may include but are not limited to voltage levels of the electrostatic fields, water level of the fluid, particle counts of the fluid, flow rate of the fluid, temperature of the filtration and separation system 108, volume, pressure, viscosity, thermal properties, Reynolds number and/or any other type of characteristic and/or analytic that may be an identifiable parameter of the fluid and/or an indicator of the performance of the filtration and separation system 108 that will be apparent to those skilled in the relevant art(s) without departing from the spirit and scope of the disclosure.

The filtration computing device 1210 may simplify the analytics with regard to the filtration of the filtration and separation system 108 even further from the visual graph while still providing the user with insight as to the performance of the filtration and separation system 108 that is easily understood. As mentioned above, the user may be responsible for monitoring numerous filtration and separation systems 200 included in the filtration computing configuration 1200, such as a factory that includes numerous filtration and separation systems 200. The user may also be responsible for many other facets of the factory in addition to the filtration and separation systems 200 and/or numerous other filtration and separation systems 200 and may not be able to routinely analyze easily understood analytics such as the visual graph and/or the other easily understood analytics generated by the filtration computing device 1310.

Thus, the filtration computing device 1210 may simply provide the status of the filtration and separation system 108 with regard to different characteristics of the filtration based on a threshold for each of the different characteristics. The filtration computing device 1210 may monitor each of the different characteristics to determine whether any of the different characteristics exceeds or deviates below a threshold for the filtration and separation system 108. The threshold for each of the different characteristics may be customized for each specific characteristic. Each threshold may be based on a level in which the specific characteristic exceeds or deviates below and thus provides a significant indication that the performance of the filtration and separation system 108 is degrading and requires the attention of the user.

The filtration computing device 1210 may generate an alert and provide that alert to the user via the filtration monitoring computing device 1230 when the specific characteristic exceeds or deviates below the designated threshold of the specific characteristic. Rather than requiring the user to monitor the visual graph for each characteristic and/or analyze other more complicated analytics generated by the filtration computing device 1210, the filtration computing device 1210 may generate an alert so the user is notified when any of the characteristics have exceeded and/or have deviated below the specified threshold for each characteristic. The user may then drill down further and request more detailed analytics but yet still be easily understandable, such as the visual graph of the failing characteristic, to gain further analysis of what has occurred with regards to the failing characteristic.

For example, the initial voltage level applied to the electrostatic fields of the collector element 160 of the filtration and separation system 108 when initially filtering the fluid of the working machine 104 is 13 kV. As the filtration and separation system 108 continues to filter the fluid of the working machine 104 and the collector element 160 collects varnish and/or unwanted particles from the fluid, the voltage level of the electrostatic field may gradually decrease over time as the collector element 160 continues to collect varnish and/or unwanted particles and becomes gradually less effective in removing varnish and/or unwanted particles from the fluid indicating a degradation in the performance in the filtration and separation system 108. The threshold of the voltage level when deviated below provides a significant indication that the performance of the collector element 160 has degraded to a point where the collector element 160 requires the attention of the user is 4.0 kV. The filtration computing device 1210 then generates an alert to the user when the voltage level of the electrostatic fields deviates below the threshold of 4.0 kV indicating to the user that the collector element 160 requires attention.

As noted above, the filtration and separation system 108 may have characteristics of filtration that increase and/or decrease as the filtration and separation system cycles through the fluid and may not remain constant. Further, the filtration and separation system 108 may also have spikes and/or drops in characteristics as the filtration and separation system 108 filters the fluid as the working machine 104 operates that may not necessarily occur in each cycle of the working machine 104 but such a spike and/or drop may still not be a significant indication that the performance of the working machine 104 is degrading. As noted above, the user may have significant responsibilities with regards to monitoring numerous filtration and separation systems 108 and/or additional responsibilities and may not have the bandwidth to track down each and every alert generated for characteristics that exceed or deviates below the threshold during normal operation of the filtration and separation system 108.

Thus, the filtration computing device 1210 may determine an average voltage level for the electrostatic fields of the filtration and separation system 108 that excludes any spikes and/or drops in characteristics that are generated during the normal operation of the filtration and separation system 108 and are not cause of concern to the user with regards to any degradation in performance of the filtration and separation system 108. The filtration computing device 1210 may then determine the thresholds for each specific characteristic such that each threshold is customized to the specific characteristic and adequately accounts for any spikes and/or drops in the specific characteristic that are not a significant indication that the performance of the filtration and separation system 108 is degrading. The filtration computing device 1210 may then limit the alerts that are generated for the user to when a threshold is legitimately exceeded or deviated below by the specific characteristic and legitimately requires the attention of the user.

The filtration monitoring computing device 1230 may depict each of the statuses by an easily recognizable identifier. With regard to the example threshold alert configuration 1400 in FIG. 14, the filtration monitoring computing device 1230 displays each of the statuses via the user interface 1250 via two different colors. The filtration monitoring computing device 1230 depicts the status of the characteristic that has not exceeded or deviated below its respective threshold with the status identifier of “green” in which the color “green” is a status that is universally recognized as having no concern. The filtration monitoring computing device 1230 depicts the status of the characteristic that exceeded or deviated below its respective threshold and generates an alert with the status identifier of “red” in which the color “red” is a status that is universally recognized as there is cause for concern.

Specifically, the example threshold alert configuration 1400 in FIG. 14 provides the status of the characteristic of voltage level of the electrostatic fields generated by the working fluid filtration and separation system 108. The filtration computing device 1210 may stream to the filtration monitoring computing device 1230 the status of the voltage level of the electrostatic fields with regard to whether the voltage level has decreased below the threshold and the filtration monitoring computing device 1230 may display the status via the voltage level indicator 1410. As the voltage level of the electrostatic fields decreases and continues to be at a decreased level over a period of time, such a decrease may be indicative that the collector element 160 is no longer adequately removing varnish and unwanted particles from the fluid and requires the attention of the user.

Thus, the filtration computing device 1210 determines whether the voltage level of the electrostatic fields have decreased below the threshold, and if so, streams to the filtration monitoring computing device 1230 an alert that the voltage level has decreased below the threshold. The filtration monitoring computing device 1230 then displays the voltage level status indicator 1410 as “green” when the voltage level remains above the threshold and then displays the voltage level status indicator 1410 as “red” as an alert when the voltage level decreases below the threshold. The filtration computing device 1210 may also stream filtration data associated with the voltage level to the filtration monitoring computing device 1230 that the filtration monitoring computing device 1230 may display. For example, the example threshold alert configuration 1400 in FIG. 14, displays the latest voltage level measurement is 10 kV and was measured at 12:28 AM on Feb. 9, 2015.

The example threshold alert configuration 1400 in FIG. 14 also provides the status of the characteristic of water level of the fluid that is flowing through the filtration and separation system 108. The filtration computing device 1210 may stream to the filtration monitoring computing device 1230 the status of the water level of the fluid flowing through the filtration and separation system 108 with regard to whether the water level of the fluid has exceeded the threshold and the filtration monitoring computing device 1230 may display the status via the status water level indicator 1420. As the water level of the fluid increases and continues to be at an increased level over a period of time, such an increase may be indicative that the performance of the fluid that the working machine 104 is operating with is degrading and requires the attention of the user.

The working machine 104 operates with a fluid which includes characteristics that enable the working machine 104 to continuously operate and prevent wear on the mechanical components of the working machine 104. As the working machine 104 operates, the percentage of water included in the fluid relative to the characteristics of the fluid that have a positive impact on the working machine 104 increases. As the percentage of water included in the fluid relative to the characteristics of the fluid that have a positive impact on the working machine 104 increases, the amount of positive characteristics of the fluid decrease.

Further as the percentage of water included in the fluid increases relative to the positive characteristics, sludge as well as other varnishes may begin to formulate in the fluid. Rather than removing sludge, varnish and/or other unwanted particles from the fluid, an increase in water included in the fluid may actually generate additional sludge, varnish, and/or other unwanted particles as the filtration and separation system 108 attempts to remove such from the fluid. Once the percentage of water included in the fluid relative to the positive characteristics of the fluid reaches saturation, the increased amount of water in the fluid may have a negative impact on the mechanical components of the working machine 104 as the working machine operates 102 and the degradation of the mechanical components of the working machine 104 may increase at faster rates.

Thus, the filtration computing device 1210 determines whether water level of the fluid flowing through the filtration and separation system 108 has exceeded the threshold, and if so, streams to the filtration monitoring computing device 1230 an alert that the water level has exceeded the threshold. However, the filtration computing device 1210 may determine whether the water level of the fluid flowing through the filtration and separation system 108 exceeds several different thresholds, with each threshold indicating a different type of response required by the user in order to address the water level exceeding the respective threshold.

The water level exceeding a high threshold may require more aggressive actions by the user than when the water level exceeds lower thresholds. For example, the water level exceeding a high threshold may indicate to the user that aggressive water removal efforts should be executed such as but not limited to incorporating a vacuum dehydration system and/or a coalescing water removal system to remove the water from the fluid. Such aggressive removal efforts may require significant amounts of electricity so the user may request to be alerted to these types of water removal efforts only when the water level exceeds a high threshold. In doing so, the filtration monitoring computing device 1230 may display the water level status indicator 1420 as “red” when the water level exceeds the high threshold and requires aggressive water removal efforts.

The water level exceeding a low threshold may require less aggressive actions by the user when the water level exceeds the high threshold but still requires the attention of the user. For example, the water level exceeding a low threshold may indicate to the user that less aggressive water removal efforts should be executed such as but not limited to executing low point drain activation where the reservoir 104 is drained to remove water. Such remedial removal efforts may not require significant amounts of electricity but still may be necessary to prevent the water level from exceeding the high threshold. In doing so, the filtration monitoring computing device 1230 may display the water level status indicator 1420 as “yellow” when the water exceeds the low threshold and requires less aggressive water removal efforts.

The filtration computing device 1210 may also determine whether the water level of the fluid has decreased below the low threshold, and if so, streams to the filtration monitoring computing device 1230 that the water level of the fluid remains below the low threshold. The filtration monitoring computing device 1230 then displays the water level status indicator 1420 as “green” when the water level remains below the low threshold indicating that the water level of the fluid is adequate and does not require immediate attention. The filtration computing device 1210 may also stream filtration data associated with the water level to the filtration monitoring computing device 1230 that the filtration monitoring computing device 1230 may display. For example, the example threshold alert configuration 1400 in FIG. 14, displays the latest water level measurement is 10% and was measured at 12:28 AM on Feb. 9, 2015.

In an embodiment, the example threshold alert configuration 1400 in FIG. 14 also provides the status of the characteristic of the particle count of the unwanted particles included in the fluid as the filtration and separation system 108 removes the unwanted particles from the fluid. The filtration computing device 1210 may stream to the filtration monitoring computing device 1230 the status of the particle count level of the unwanted particles included in the fluid with regard to whether the particle count has spiked above a high threshold and the filtration monitoring computing device 1230 may display the status of the high threshold via the status particle count indicator 1430.

As the particle count level of the unwanted particles included in the fluid increases and continues to be at an increased level over a period of time, such an increase may be indicative that the filtration and separation system 108 is no longer adequately removing the varnish and/or unwanted particles from the fluid and/or the working machine 104 is no longer operating property generating a spike in unwanted particles into the fluid and requires the attention of the user. Thus, the filtration computing device 1210 determines whether the particle count of unwanted particles included in the fluid has exceeded the high threshold, and if so, streams to the filtration monitoring computing device 1230 an alert the at the particle count level of unwanted particles has exceeded the high threshold. The filtration monitoring computing device 1230 then displays the particle count level status indicator 1430 as “red” when the particle count level of unwanted particles has exceeded the threshold indicating that attention to the filtration and separation system 108 is required by the user.

The filtration computing device 1210 may also stream to the filtration monitoring computing device 1230 the status of the particle count level of the unwanted particles included in the fluid with regard to whether the particle count has decreased below a low threshold and the filtration monitoring computing device 1230 may display the status of the low threshold via the status particle count indicator 1430.

As the particle count level of the unwanted particles included in the fluid decreases and continues to be at a decreased level over a period of time, such a decrease may be indicative that the filtration and separation system 108 continues to adequately remove the varnish and/or unwanted particles from the fluid. Thus, the filtration computing device 1210 determines whether the particle count of unwanted particles included in the fluid continues to be below the low threshold, and if so, streams to the filtration monitoring computing device 1230 that the particle count level of unwanted particles continues to remain below the low threshold. The filtration monitoring computing device 1230 then displays the particle count level status indicator 1430 as “green” when the particle count level of unwanted particles remains below the low threshold indicating that consideration as to whether the filtration and separation system 108 is even necessary for the working machine 104 may be considered. For example, the example threshold alert configuration 1400 in FIG. 14 displays the latest particle count measurements of unwanted particles is 95 and was measured at 12:28 AM on Feb. 9, 2015.

In an embodiment, the example threshold configuration 1400 in FIG. 14 also provides the status of the characteristic of the particle count of unwanted particles removed from the fluid by the filtration and separation system 108. The filtration computing device 1210 may stream to the filtration monitoring computing device 1230 the status of the particle count level of unwanted particles removed from the fluid with regard to whether the particle count of unwanted particles has decreased below a threshold and the filtration monitoring computing device 1230 may display the status of the threshold via the status particle count indicator 1430.

As the particle count level of unwanted particles removed from the fluid decreases and continues to be at a decreased level over a period of time, such a decrease may be indicative that the filtration and separation system 108 is no longer adequately removing the varnish and/or unwanted particles from the fluid generating a decrease in the unwanted particles removed from the fluid and requires the attention of the user. Thus, the filtration computing device 1210 determines whether the particle count of unwanted particles included in the fluid has decreased below the threshold, and if so, streams to the filtration monitoring computing device 1230 an alert that the particle count level of unwanted particles removed from the fluid has decreased below the threshold. The filtration monitoring computing device 1230 then displays the particle count level status indicator 1430 as “red” when the particle count level of unwanted particles has decreased below the threshold indicating that attention to the filtration and separation system 108 is required by the user.

The filtration computing device 1210 also determines whether the particle count of unwanted particles removed from the fluid continues to exceed the threshold, and if so, streams to the filtration monitoring computing device 1230 that the particle count level of unwanted particles removed from the fluid continues to remain above the threshold. The filtration monitoring computing device 1230 then displays the particle count level status indicator 1430 as “green” when the particle count level of unwanted particles removed from the fluid remains above the threshold indicating that the filtration and separation system 108 does not require immediate attention. For example, the example threshold alert configuration 1400 in FIG. 14 displays the latest particle count measurements of unwanted particles removed from the fluid is 95 and was measured at 12:28 AM on Feb. 9, 2015.

The example threshold alert configuration 1400 in FIG. 14 also provides the status of the characteristic of the fluid flow fluid flowing from the working machine 104 through the filtration and separation system 108. The fluid computing device 1210 may stream to the fluid monitoring computing device 1230 the status of the fluid flow with regards to whether the fluid flow has deviated below the threshold and the fluid monitoring computing device 1230 may display the status via the status fluid flow indicator 1440.

The fluid flow flowing through the filtration and separation system 108 may be an indicator that the working machine 104 is operating and is flushing fluid through the filtration and separation system 108 such that the fluid may be filtered by the filtration and separation system 108 to remove the varnish and/or unwanted particles from the fluid. As the fluid flow of the filtration and separation system 108 remains above the threshold, such fluid flow above the threshold may be an indicator that the working machine 104 is indeed operational and that the filtration and separation system 108 should be activated and applying the voltage to generate the electrostatic fields to remove the varnish and/or unwanted particles from the fluid.

However, as the fluid flow of the filtration and separation system 108 dips below the threshold, such fluid flow of the filtration and separation system 108 that remains below the threshold may be an indicator that the working machine 104 is not currently operational and is not currently flushing fluid through the filtration and separation system 108. As a result, the filtration and operational system 200 being operational and applying the voltage to generate the electrostatic fields is not necessary as the filtration and operational system 200 is applying unnecessary electricity to remove varnish and/or unwanted particles from fluid that is not presently flowing through the filtration and separation system 108.

Thus, the fluid computing device 1210 determines whether the fluid flow of the fluid flowing through the filtration and separation system 108 has deviated below the threshold, and if so, streams to the fluid monitoring computing device 1230 an alert that the fluid flow has deviated below the threshold. The fluid monitoring computing device 1230 then displays the fluid flow status indicator 1440 as “green” when the fluid flow remains above the threshold and then displays the fluid flow status indicator 1440 as “red” as an alert when the fluid flow deviates below the threshold. The fluid computing device 1210 may also stream filter data associated with the fluid flow to the fluid monitoring computing device 1230 that the fluid monitoring computing device 1230 may display. For example, the example threshold alert configuration 1400 in FIG. 14 displays the latest fluid flow measurement as 82 GPM and was measured at 12:28 AM on Feb. 9, 2015.

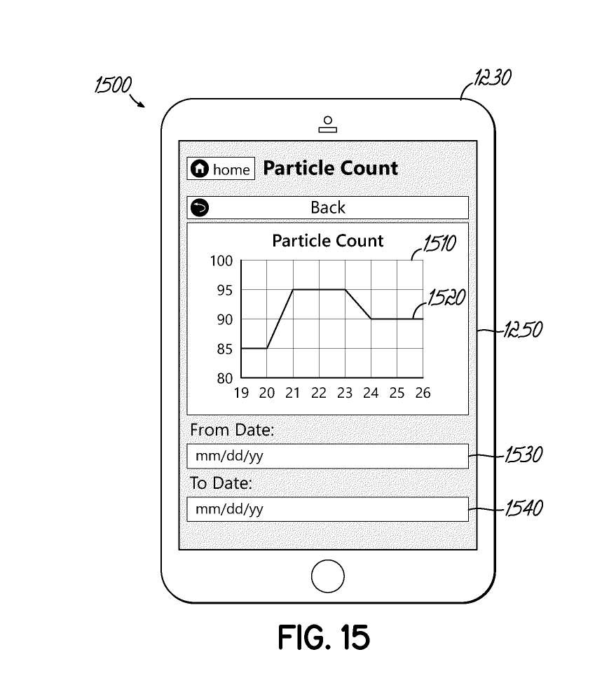

In another example, FIG. 15 depicts an example visual graph configuration 1500 in which the filtration monitoring computing device 1230 displays a visual graph of the particle count level of the filtration and separation system 108 via the user interface 1250 of the filtration monitoring computing device 1230. As noted above, the particle count level of the filtration and separation system 108 may provide meaningful insight as to the performance of the filtration and separation system 108. The particle count level may be the amount of particles included in the fluid that is flowing through the filtration and separation system 108 as the working machine 104 operates. For example, the particle count may include the amount of varnish and/or unwanted particles included in the fluid that the filtration and separation system 108 is to filter out of the fluid as the working machine 104 operates.

Typically, the fluid flowing through the filtration and separation system 108 includes an amount of particles as the working machine 104 operates. The particles included in the fluid may be unwanted and are to be filtered out by the filtration and separation system 108 in order to prevent degradation of the working machine 104 as the working machine 104 operates. Such particles may be generated as the working machine 104 operates. For example, the particle count level of the fluid may significantly increase from increased wear of the working machine 104 and/or a failure in the working machine 104. Such an increase in the particle count may indicate that the working machine 104 and/or the filtration and separation system 108 should be addressed by the user.

The particle count level may also include the amount of varnish and/or unwanted particles removed from the fluid by the filtration and separation system 108 as the working machine 104 operates. For example, the particle count level of the fluid may gradually decrease as the filtration and separation system 108 removes the varnish and/or unwanted particles from the fluid as the working machine 104 operates.

As the filtration and separation system 108 operates over periods of time as the working machine 104 operates, the particle count level indicating the amount of unwanted particles included in the fluid may be tracked. A sudden increase in the particle count level may indicate an influx of contaminants and/or metallic debris into the fluid and the user may be alarmed as to an issue with the working machine 104 such as significant degradation of the working machine 104. Continuous low levels of the particle count may indicate proper operation of the filtration and separation system 108 as the increased levels of unwanted particles included in the fluid are being prevented.

Further, the particle count level indicating the amount of unwanted particles that have been removed from the fluid by the filtration and separation system 108 may also be monitored. A drop in the amount of unwanted particles being filtered from the fluid by the filtration and separation system 108 may be indicative that the filtration and separation system 108 is no longer adequately removing the varnish and/or unwanted particles from the fluid. Continuous high levels of the particle count may indicate proper operation of the filtration and separation system 108 as continuous increased levels of unwanted particles are being removed from the fluid. In an embodiment, the different size ranges of the size of unwanted particles removed by the filtration and separation system 108 may be monitored and tracked such that the efficiency in the removal of different types of unwanted particles removed by the filtration and separation system 108 may be monitored and tracked. The overall efficiency of the overall amount of unwanted particles removed by the filtration and separation system 108 may also be monitored and tracked.

As the level of unwanted particles included in the fluid spikes above the threshold level, such a spike above the threshold level may be an indication that the filtration and separation system 108 and/or the working machine 104 should be inspected and/or replaced as having a spike of unwanted particles included in the fluid. Thus, as the level of unwanted particles included in the fluid increases, the performance of the filtration and separation system 108 and/or the working machine 104 may also be decreasing.

Further, as the level of unwanted particles included in the fluid remains below a threshold level, such a low level of unwanted particles included in the fluid may be indicative that the fluid no longer requires to be filtered by the filtration and separation system 108. An alert may be generated indicating that the filtration and separation system 108 may be deactivated to conserve energy as the fluid no longer requires filtration. An alert may also be generated indicating that the filtration and separation system 108 may be moved to a different working machine 104 such that the filtration and separation system 108 may filter the fluid of a different working machine 104.

Further, as the level of unwanted particles that are removed from the fluid by the filtration and separation system remains above a threshold, such a maintaining of the level of unwanted particles removed from the fluid may be an indication that the filtration and separation system 108 and/or the working machine are operating properly and no action is required. The level of unwanted particles removed from the filtration and separation system that fall below a threshold, such a decrease in the level of unwanted particles removed from the fluid may be an indication that the filtration and separation system 108 is not operating properly and action is required.

In an embodiment, the example visual graph configuration 1500 depicted in FIG. 15 depicts how the particle count level of the fluid has deviated over a period of time. As can be seen in FIG. 15, the user interface 1250 of the filtration and monitoring computing device 1230 depicts a visual graph 1510 for the filtration and separation system 108 during a continuous operation of the filtration and separation system 108 as the filtration and separation system 108 filters the fluid from the reservoir 104 that is supplied to the working machine 104 as the working machine 104 operates and the filtration and separation system 108 removes the varnish and/or unwanted particles from the fluid as the working machine 104 operates.

The particle count level included in the fluid begins at a lower value on the plot 1520 during the initial stages as the filtration and separation system 108 initially begins filtering the fluid from the reservoir 104 that is supplied to the working machine 104 as the working machine 104 operates. As noted above, the initial particle count included in the fluid may be 85. As the working machine 104 operates over time, the amount of unwanted particles included in the fluid may gradually increase.

Eventually, the particle count level of unwanted particles included in the fluid increases to 95 and may be indicative that filtration and separation system 108 is no longer effective in removing the varnish and/or unwanted particles from the fluid and/or there is an issue with the working machine 104 in which the working machine 104 is generating a increased amount of unwanted particles.

In an embodiment, the example visual graph configuration 1500 depicted in FIG. 15 depicts how the particle count level removed from the fluid by the filtration and separation system has deviated over a period of time. As can be seen in FIG. 15, the user interface 1250 of the filtration and monitoring computing device 1230 depicts a visual graph 1510 for the filtration and separation system 108 during a continuous operation of the filtration and separation system 108 as the filtration and separation system 108 filters the fluid from the reservoir 104 that is supplied to the working machine 104 as the working machine 104 operates and the filtration and separation system 108 removes the varnish and/or unwanted particles from the fluid as the working machine 104 operates.

The particle count level of the unwanted particles removed from the fluid begins at a lower value on the plot 1520 during the initial stages as the filtration and separation system 108 initially begins filtering the fluid from the reservoir 104 that is supplied to the working machine 104 as the working machine 104 operates. As noted above, the initial particle count removed from the fluid may be 85. As the filtration and separation system 108 operates over time, the amount of varnish and/or unwanted particles removed from the fluid may gradually increase to 95.

Eventually, the filtration and separation system 108 may no longer remove as much varnish and/or unwanted particles over time. For example, the collector element 160 may no longer remove the varnish and/or unwanted particles as effectively as the amount of varnish and/or unwanted particles absorbed by the collector element 160 increases. In doing so, the particle level of unwanted particles removed from the fluid may decrease from 95 to 90 and may be indicative that the filtration and separation system 108 is no longer effective in removing the varnish and/or unwanted particles from the fluid and that the filtration and separation system should be addressed.

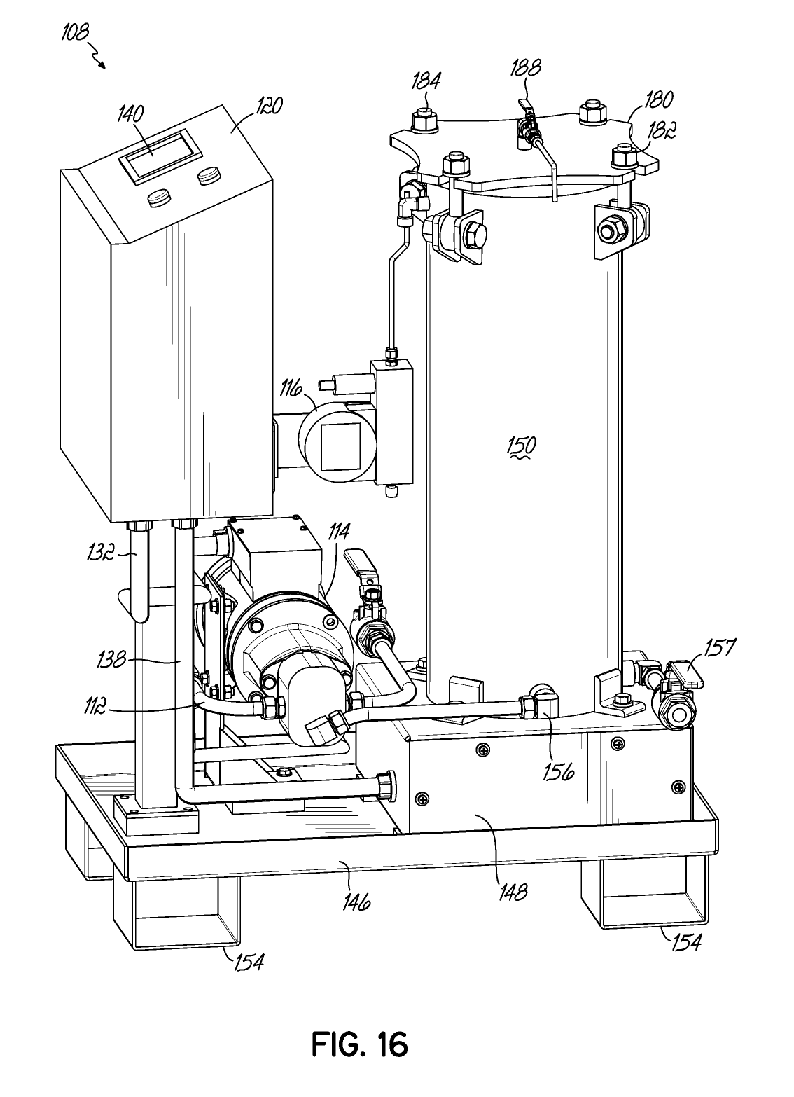

The construction of an additional working fluid and separation system is shown in FIG. 16. The embodiment of the working fluid and separation system 108 shown in FIG. 16 operates in a similar manner as the additional embodiments of the working and fluid and separation system 108 discussed in detail above. In FIG. 16, the one or more sensors 116 may be positioned between the vessel 150 and the control system 120.

While various aspects in accordance with the principles of the invention have been illustrated by the description of various embodiments, and while the embodiments have been described in considerable detail, they are not intended to restrict or in any way limit the scope of the invention to such detail. The various features shown and described herein may be used alone or in any combination. Additional advantages and modifications will readily appear to those skilled in the art. The invention in its broader aspects is therefore not limited to the specific details and representative devices shown and described. Accordingly, departures may be made from such details without departing from the scope of the general inventive concept.

What is claimed is:

1. A working fluid filtration and separation system for removing contaminants from a working fluid of a working machine, comprising:
a vessel having an inlet and an outlet, the vessel being configured such that the working fluid flows through the vessel between the inlet and the outlet;
an electrostatic collector element mounted within the vessel, the electrostatic collector element comprising:
a plurality of concentric electrodes of different radii; and
a plurality of filters residing in spaces located between adjacent electrodes;
an elongated center post electrode mounted within a space defined by an inner-most electrode of the electrostatic collector element and being electrically coupled to at least one of the plurality of concentric electrodes;
a center post isolator mounted adjacent a bottom end of the vessel, the center post isolator being configured to mount the center post electrode within the vessel and electrically insulate the center post electrode from the vessel; and
an electrical conductor at least partially mounted within the center post isolator, the electrical conductor being mechanically and electrically coupled to the center post isolator and configured to apply a voltage to the center post electrode,
wherein the electrostatic collector element is operable to remove contaminants from the working fluid in response to the voltage being applied to the center post electrode.

2. The system of claim 1, wherein the center post electrode is mechanically coupled to the electrical conductor via a threaded screw connection.

3. The system of claim 1, wherein the vessel includes a bottom wall having an aperture formed therethrough, and further wherein a portion of the center post isolator extends through the aperture and into the vessel.

4. The system of claim 3, wherein a seal is provided between the center post isolator and the bottom wall of the vessel.

5. The system of claim 1, wherein a seal is provided between the electrical conductor and the center post electrode.

6. The system of claim 3, wherein the center post isolator includes a first shell structure located at one end of center post isolator, a second shell structure located at an opposite end of the center post isolator and an elongated bore communicating with the first shell structure and the second shell structure.

7. The system of claim 6, wherein the first shell structure has a first inner diameter, the second shell structure has a second inner diameter, and the elongated bore has a third inner diameter which is less than each of the first and second inner diameters.

8. The system of claim 7, wherein the center post isolator includes a radially outwardly directed disk extending from a body of the center post isolator.

9. The system of claim 8, wherein the radially outwardly directed disk is mounted to the bottom wall of the vessel.

10. The system of 7, wherein the electrical conductor is at least partially mounted within the first shell structure, the second shell structure and the elongated bore.

11. The system of claim 1, further comprising a control system configured to control the voltage applied to the center post electrode.

12. A working fluid filtration and separation system for removing contaminants from a working fluid of a working machine, comprising:
a vessel having an inlet and an outlet, the vessel being configured such that the working fluid flows through the vessel between the inlet and the outlet;
an electrostatic collector element mounted within the vessel, the electrostatic collector element being operable to remove contaminants from the working fluid located within the vessel; and
a pump configured to circulate the working fluid through the vessel between the inlet and outlet,
wherein the pump comprises one of a variable frequency drive or a variable displacement pump.

13. The system of claim 12, further comprising an inlet of the system being in fluid communication with the inlet of the vessel and an outlet of the system being in fluid communication with the outlet of the vessel.

14. The system of claim 13, further comprising at least one sensor configured to measure at least one of temperature, pressure, humidity or flow rate of the working fluid at a selected location between the inlet and outlet of the system.

15. The system of claim 13, further comprising at least one sensor configured to measure a volume density of particulate contaminants in the working fluid at a selected location between the inlet and outlet of the system.

16. The system of claim 13, further comprising at least one sensor configured to measure a presence of water in the working fluid at a selected location between the inlet and outlet of the system.

17. The system of claim 13, further comprising at least one sensor configured to measure a dielectric strength of the working fluid at a selected location between the inlet and outlet of the system.

18. The system of claim 13, further comprising at least one sensor configured to measure an electric charge or electric field strength of the working fluid at a selected location between the inlet and outlet of the system.

19. The system of claim 13, further comprising at least one sensor configured to measure a chemical spectrum of the working fluid at a selected location between the inlet and outlet of the system.

20. The system of claim 13, further comprising a control system configured to control operation of the pump so as to control a flow rate of the working fluid between the inlet and outlet of the system.

21. The system of claim 13, further comprising a working fluid tank configured to contain the working fluid, with the inlet and outlet of the system being in fluid commination with the working fluid tank.

22. The system of claim 21, further comprising a working fluid contained in the working fluid tank.
